(19) United States
(12) Patent Application Publication
(10) Pub. No.: US 2020/0098254 A1
(43) Pub. Date: Mar. 26, 2020

(54) ROADSIDE UNIT

(71) Applicant: KYOCERA Corporation, Kyoto (JP)

(72) Inventor: Takahiro OYABU, Tokyo (JP)

(73) Assignee: KYOCERA Corporation, Kyoto (JP)

(21) Appl. No.: 16/695,036

(22) Filed: Nov. 25, 2019

Related U.S. Application Data
(63) Continuation of application No. PCT/JP2018/019637, filed on May 22, 2018.

(30) Foreign Application Priority Data
May 26, 2017 (JP) 2017-104758

(51) Int. Cl. G08G 1/09; H04W 72/04; H04W 4/44; H04W 76/10; H04L 12/28; H04B 7/06; H04W 84/18; H04W 88/10

(52) U.S. Cl. CPC G08G 1/09; H04W 72/04; H04W 4/44; H04W 88/10; H04L 12/28; H04B 7/06; H04W 84/18; H04W 76/10

(57) ABSTRACT

A roadside unit comprises a first communication unit and a second communication unit. The first communication unit is configured to perform communication, based on a first wireless communication method. The second communication unit is configured to perform communication, based on a second wireless communication method different from the first wireless communication method. The first communication unit transmits connection setting information necessary for connection setting with the second communication unit.

### CROSS-REFERENCE TO RELATED APPLICATION

The present application is a continuation based on PCT Application No. PCT/JP2018/019637 filed on May 22, 2018, which claims the benefit of Japanese Application No. 2017-104758, filed on May 26, 2017. PCT Application No. PCT/JP2018/019637 is entitled “ROAD SIDE DEVICE, COMMUNICATION DEVICE, VEHICLE, AND TRANSMISSION METHOD”, and Japanese Application No. 2017-104758 is entitled “ROAD SIDE DEVICE, COMMUNICATION DEVICE, VEHICLE, AND TRANSMISSION METHOD”. The contents of which are incorporated by reference herein in their entirety.

### FIELD

The present disclosure relates to a roadside unit.

### BACKGROUND

Hitherto, a technology relating to a roadside unit has been proposed.

### SUMMARY

A roadside unit, a communication apparatus, a vehicle, a method of transmitting are disclosed. In one embodiment, a roadside unit comprises a first communication unit and a second communication unit. The first communication unit is configured to perform communication, based on a first wireless communication method. The second communication unit is configured to perform communication, based on a second wireless communication method different from the first wireless communication method. The first communication unit transmits connection setting information necessary for connection setting with the second communication unit.

In one embodiment, a communication apparatus is a communication apparatus configured to receive information transmitted by the first communication unit and the second communication unit comprised in the roadside unit, and carry out connection setting with the second communication unit, based on the connection setting information received from the second communication unit.

In one embodiment, a vehicle is a vehicle comprising the communication apparatus.

In one embodiment, a method of transmitting is a method of transmitting in a roadside unit that performs communication based on a first wireless communication method and a second wireless communication method. The method comprises transmitting connection setting information necessary for connection setting of communication of the second wireless communication method, based on the first wireless communication method.

### BRIEF DESCRIPTION OF THE DRAWINGS

FIG. 1 illustrates one example of a configuration of a communication system.

FIG. 2 illustrates one example of a configuration of a roadside unit.

FIG. 3 illustrates one example of communication areas of first and second communication units and a capture range of a camera.

FIG. 4 illustrates one example of a configuration of an on-board device.

FIG. 5 illustrates a flowchart of one example of operation of the roadside unit.

FIG. 6 illustrates one example of connection setting information.

FIG. 7 illustrates a flowchart of one example of operation of the on-board device.

FIG. 8 illustrates one example of a camera image.

FIG. 9 illustrates one example of a state in which a vehicle makes a right turn at an intersection.

FIG. 10 illustrates one example of a state in which a vehicle makes a left turn at the intersection.

FIG. 11 illustrates a flowchart of one example of operation of the on-board device.

FIG. 12 illustrates a flowchart of one example of operation of the on-board device.

FIG. 13 illustrates a flowchart of one example of operation of the on-board device.

FIG. 14 illustrates one example of a camera image.

FIG. 15 illustrates one example of a camera image.

FIG. 16 illustrates one example of an image schematically showing a state of a road.

FIG. 17 illustrates a flowchart of one example of operation of the roadside unit.

FIG. 18 illustrates one example of capture ranges of a plurality of cameras.

FIG. 19 illustrates one example of communication areas of a plurality of second communication units.

FIG. 20 illustrates one example of pieces of notice information and connection setting information that correspond to respective second communication units.

FIG. 21 illustrates one example of capture ranges of the plurality of cameras and the communication areas of the plurality of second communication units.

FIG. 22 illustrates one example of pieces of notice information and connection setting information that correspond to respective channels.

FIG. 23 illustrates one example of directivity of a first communication unit.

FIG. 24 illustrates one example of directivity of the first communication unit.

FIG. 25 illustrates one example of a state in which the roadside unit comprising the first communication unit having directivity comprises the plurality of cameras.

FIG. 26 illustrates one example of a state in which the roadside unit comprising the first communication unit having directivity comprises the plurality of second communication units.

FIG. 27 illustrates one example of a state in which the roadside unit comprising the first communication unit having directivity comprises the plurality of cameras and the plurality of second communication units.

### DETAILED DESCRIPTION

<Example of Configuration of Communication System>

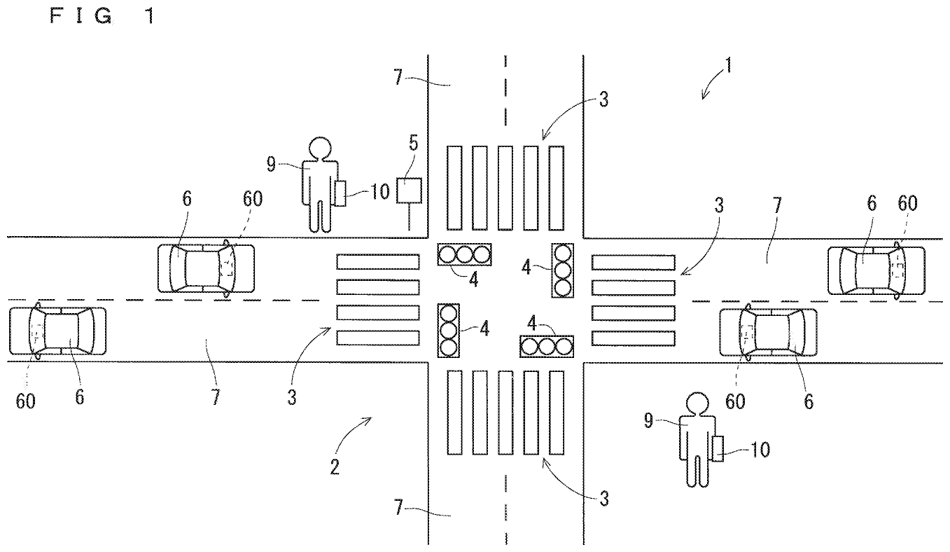

FIG. 1 illustrates one example of a communication system 1. The communication system 1 is, for example, a driving safety support communication system of intelligent transport systems (ITS: Intelligent Transport Systems). The driving safety support communication system may be referred to as a driving safety support system, or a driving safety support wireless system.

As illustrated in FIG. 1, the communication system 1 comprises a roadside unit 5. The roadside unit 5 is, for example, disposed at an intersection 2 where a plurality of roads (such as roadways) 7 are connected. FIG. 1 illustrates an intersection 2 where four roads 7 are connected. However, the number of the plurality of roads 7 connected at the intersection 2 may be other than four. Further, the roadside unit 5 may be disposed in a road other than the intersection 2.

In the communication system 1, the roadside unit 5, a vehicle 6 such as an automobile that travels in the road 7, and an electronic device 10 owned by a pedestrian 9 wirelessly communicate with one another. With this, the roadside unit 5, the vehicle 6, and the electronic device 10 can exchange information with one another. Further, a plurality of vehicles 6 can wirelessly communicate with one another. With this, the plurality of vehicles 6 can exchange information with one another. Communication between the roadside unit 5 and the vehicle 6, communication between the vehicles 6, communication between the roadside unit 5 and the electronic device 10 carried by the pedestrian 9, and communication between the electronic device 10 carried by the pedestrian and the vehicle 6 are referred to as roadside-vehicle communication, inter-vehicle communication, roadside-pedestrian communication, and pedestrian-vehicle communication, respectively.

The electronic device 10 is, for example, a mobile phone such as a smartphone. The electronic device 10 can specify a state of a user of the electronic device 10 (such as the pedestrian 9), based on detection results of its own accelerometer etc. For example, the electronic device 10 can specify whether or not a user stops, or whether or not a user is moving. Further, in a case where a user is moving, the electronic device 10 can specify moving means thereof. For example, the electronic device 10 can specify whether a user is moving on foot, by bicycle, or by automobile, etc. The electronic device 10 can inform the roadside unit 5 etc. about information of a state of a specific user etc.

Note that, the electronic device 10 may be an electronic device other than a mobile phone. The electronic device 10 may be, for example, a tablet terminal, a personal computer, a wearable device, etc. A wearable device adopted as the electronic device 10 may be a type worn in the arm such as a wristband type and a wristwatch type, a type worn in the head such as a headband type and an eyeglass type, or a type worn in the body such as a clothing type. In the description below, the electronic device 10 may be referred to as a mobile device 10.

The roadside unit 5 can inform the vehicle 6 and the electronic device 10 about driving safety support information for supporting safe driving of a driver of the vehicle 6. The driving safety support information includes, for example, information of lighting of a traffic light 4, information of road traffic control, and road line shape information (i.e., road linear information) indicating the shape of the intersection 2 where the roadside unit 5 is disposed (such as the shape of the road 7) or the like. Further, the roadside unit 5 can detect the vehicle 6 and the pedestrian 9 present in its vicinity. The roadside unit 5 can detect, for example, the pedestrian 9 passing across a crosswalk 3. Further, the roadside unit 5 can detect the vehicle 6 on each road 7. Further, the roadside unit 5 can detect, in each road 7, the vehicle 6 approaching toward the center portion of the intersection 2 from the road 7. The roadside unit 5 can inform the vehicle 6 and the electronic device 10 about information of the detected vehicle 6 and pedestrian 9 with the information being included in the driving safety support information. Further, the roadside unit 5 can also inform another vehicle 6 and another electronic device 10 about information that is informed of by the vehicle 6 and the electronic device 10 with the information being included in the driving safety support information. In the description below, driving safety support information may be simply referred to as support information.

The vehicle 6 can inform another vehicle 6, the roadside unit 5, and the electronic device 10 about vehicle information of the vehicle 6 from an on-board electronic device 60 mounted in the vehicle 6. The vehicle 6 transmits vehicle information regularly, for example. The vehicle information includes, for example, information of the position of the vehicle 6, the velocity of the vehicle 6, turn signals of the vehicle 6, etc. Further, using the on-board electronic device 60 mounted in the vehicle 6, the vehicle 6 can receive various pieces of information informed of by the roadside unit 5 etc. Further, the vehicle 6 can support safe driving of a driver by issuing various notices such as warning to the driver based on its own vehicle information and information informed of by the roadside unit 5 etc. Using the on-board electronic device 60 mounted in the vehicle 6, the vehicle 6 can issue various notices to a driver. For example, at the time of making a right turn at the intersection 2, the vehicle 6 can inform a driver that another vehicle 6 is approaching in front, and can inform a driver that the pedestrian 9 is present in the crosswalk 3 ahead of the right turn.

In this manner, in the communication system 1, safe driving of a driver of the vehicle 6 is supported through roadside-vehicle communication, inter-vehicle communication, roadside-pedestrian communication, and pedestrian-vehicle communication.

Note that, as the vehicle 6, one example of FIG. 1 illustrates a vehicle of an automobile. However, the vehicle 6 may be a vehicle other than an automobile. For example, the vehicle 6 may be a vehicle of a motorcycle, a vehicle of a bus, a vehicle of a streetcar, or a vehicle of a bicycle.

<Configuration Example of Roadside Unit>

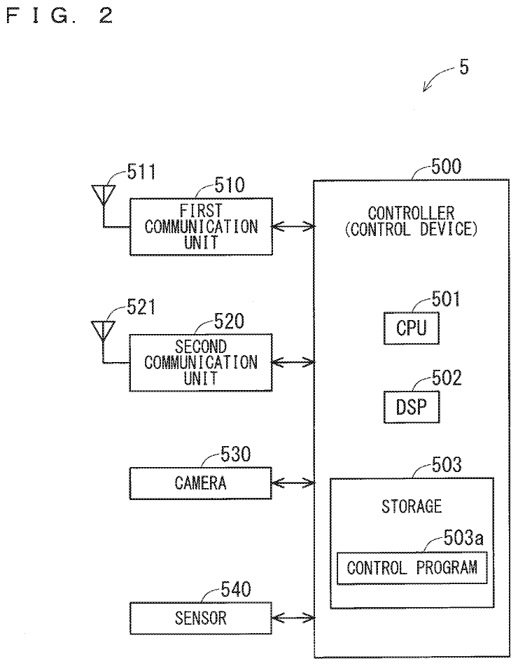

FIG. 2 illustrates one example of a configuration of the roadside unit 5. As illustrated in FIG. 2, the roadside unit 5 comprises a controller 500, a first communication unit 510, a second communication unit 520, a camera 530, and a sensor 540.

The controller 500 controls other components of the roadside unit 5, thereby being capable of integrally managing operation of the roadside unit 5. The controller 500 may also be referred to as a control device. The controller 500 comprises at least one processor for providing control and processing capability to perform various functions as described in further detail below.

In accordance with various embodiments, the at least one processor may be implemented as a single integrated circuit (IC) or as multiple communicatively coupled IC's and/or discrete circuits. It is appreciated that the at least one processor can be implemented in accordance with various known technologies.

In one embodiment, the processor includes one or more circuits or units configurable to perform one or more data computing procedures or processes by executing instructions stored in an associated memory, for example. In other embodiments, the processor may be implemented as firmware (e.g. discrete logic components) configured to perform one or more data computing procedures or processes.

In accordance with various embodiments, the processor may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein.

In one example, the controller 500 comprises a central processing unit (CPU) 501, a digital signal processor (DSP) 502, and a storage 503. The storage 503 comprises a non-transitory recording medium, such as read only memory (ROM) and random access memory (RAM), that can be read by the CPU 501 and the DSP 502. The ROM in the storage 503 is, for example, flash ROM (flash memory) being non-volatile memory. The storage 503 stores a plurality of control programs 503a etc. for controlling the roadside unit 5. The CPU 501 and the DSP 502 execute the various control programs 503a in the storage 503, thereby realizing various functions of the controller 500.

The storage 503 may comprise a non-transitory recording medium, other than ROM and RAM, that can be read by a computer. The storage 503 may comprise, for example, a small-size hard disk drive, a solid state drive (SSD), etc. At least one control program 503a in the storage 503 may be a control program stored in the storage 503 in advance. Further, at least one control program 503a in the storage 503 may be a control program download by the roadside unit 5 from another device and stored in the storage 503. Further, all of the functions of the controller 500 or a part of the functions of the controller 500 may be realized by a hardware circuit eliminating the necessity of software for realization of the functions of the hardware circuit.

The first communication unit 510 comprises an antenna 511. The first communication unit 510 may also be referred to as a communication circuit. The antenna 511 is, for example, an omnidirectional antenna. Using the antenna 511, the first communication unit 510 can wirelessly communicate with the on-board device 60 of the vehicle 6 and the electronic device 10. The first communication unit 510 can wirelessly communicate using the 700 MHz band allocated to ITS, for example. In the description below, wireless communication using the 700 MHz band allocated to ITS may be referred to as “700 MHz band communication.”

The first communication unit 510 subjects a signal received at the antenna 511 to various processing treatments such as amplification processing, and then outputs the processed received signal to the controller 500. The controller 500 subjects the input received signal to various processing treatments, thus acquiring information contained in the received signal. Further, the controller 500 outputs a transmission signal containing information to the first communication unit 510. The first communication unit 510 subjects the input transmission signal to various processing treatments such as amplification processing, and then wirelessly transmits the processed transmission signal from the antenna 511.

The second communication unit 520 comprises an antenna 521. The second communication unit 520 may also be referred to as a communication circuit. The antenna 521 is, for example, an omnidirectional antenna. Using the antenna 521, the second communication unit 520 can wirelessly communicate with the on-board device 60 of the vehicle 6 and the electronic device 10. The second communication unit 520 can wirelessly communicate using a wireless local area network (LAN) such as Wifi, for example.

The second communication unit 520 subjects a signal received at the antenna 521 to various processing treatments such as amplification processing, and then outputs the processed received signal to the controller 500. The controller 500 subjects the input received signal to various processing treatments, thus acquiring information contained in the received signal. Further, the controller 500 outputs a transmission signal containing information to the second communication unit 520. The second communication unit 520 subjects the input transmission signal to various processing treatments such as amplification processing, and then wirelessly transmits the processed transmission signal from the antenna 521. In the description below, wireless communication using a wireless LAN may be referred to as “wireless LAN communication.”

Here, a channel having 10 MHz bandwidth is provided as only one channel in the 700 MHz band communication. Therefore, in one example, a transmission rate of the first communication unit 510 performing 700 MHz band communication is lower than a transmission rate of the second communication unit 520 performing wireless LAN communication.

The camera 530 can capture a state of the intersection 2 where the roadside unit 5 is installed. An image generated in the camera 530 and capturing a state of the intersection 2 is input into the controller 500. The 530 can capture a video and a still image. In the description below, an image generated in the camera 530 may be referred to as a camera image.

The sensor 540 can detect a state of the intersection 2 where the roadside unit 5 is installed. The sensor 540 comprises, for example, a 3D laser scanner, an infrared sensor, or the like. The sensor 540 may comprise a pressure sensor embedded in the intersection 2. In each of the plurality of roads 7 connected at the intersection 2, the sensor 540 can detect, for example, the pedestrian 9 and the vehicle 6 on the road 7. Further, the sensor 540 can detect the pedestrian 9 passing across the crosswalk 3. Further, in each of the plurality of roads 7 connected at the intersection 2, the sensor 540 can detect the vehicle 6 approaching toward the center portion of the intersection 2 from the road 7. The sensor 540 outputs detection results to the controller 500. The controller 500 generates driving safety support information based on the detection results from the sensor 540 etc. The configuration of the sensor 540 is not limited to the above configuration.

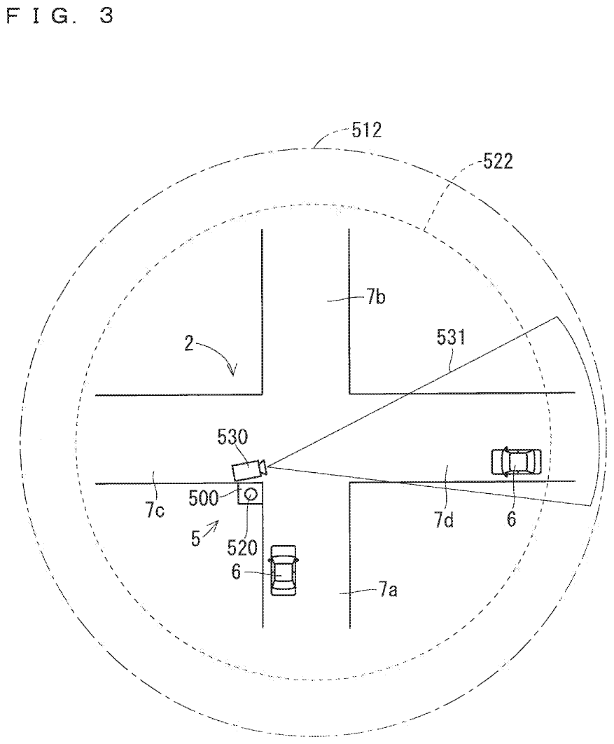

FIG. 3 illustrates one example of a communication area 512 of the first communication unit 510, a communication area 522 of the second communication unit 520, and a capture range 531 of the camera 530. In one example of FIG. 3, the communication area 512 of the first communication unit 510 (i.e., the communication area 512 of the 700 MHz band communication) covers the intersection 2 where a plurality of roads 7a to 7d are connected. Similarly, the communication area 522 of the second communication unit 520 (i.e., the communication area 522 of the wireless LAN communication) covers the intersection 2. The communication area 512 is broader than the communication area 522, and covers the entire communication area 522, for example. In one example of FIG. 3, the camera 530 can capture a state of a road 7d where an accident is particularly liable to happen among the plurality of roads 7a to 7d. Accordingly, the camera 530 can capture the vehicle 6 traveling in the road 7d. Note that, the capture range 531 of the camera 530 is not limited to one example of FIG. 3. Further, the communication areas 512 and 522 are not limited to one example of FIG. 3.

In the roadside unit 5 having the above configuration, the first communication unit 510 having a lower transmission rate transmits, under control of the controller 500, driving safety support information containing detection results of the sensor 540 etc. On the other hand, the second communication unit 520 having a higher transmission rate transmits, under control of the controller 500, an image generated in the camera 530. In this manner, the second communication unit 520 having a higher transmission rate transmits an image, thereby being capable of reducing transmission delay of an image. The on-board device 60 of the vehicle 6 having received an image from the roadside unit 5 displays the image, and thus a driver of the vehicle 6 can check a state of the road 7d in detail.

Note that, the roadside unit 5 may be capable of wirelessly communication with a base station of a mobile phone system. In this case, the roadside unit 5 can communicate with a device connected to the internet (such as a mobile phone and a web server) via a base station. Further, the roadside unit 5 may be capable of near-field wireless communication. For example, the roadside unit 5 may be capable of wireless communication in conformity with Bluetooth (registered trademark). Further, the roadside unit 5 may be capable of wireless communication on the basis of other wireless communication methods.

<Configuration Example of On-Board Device>

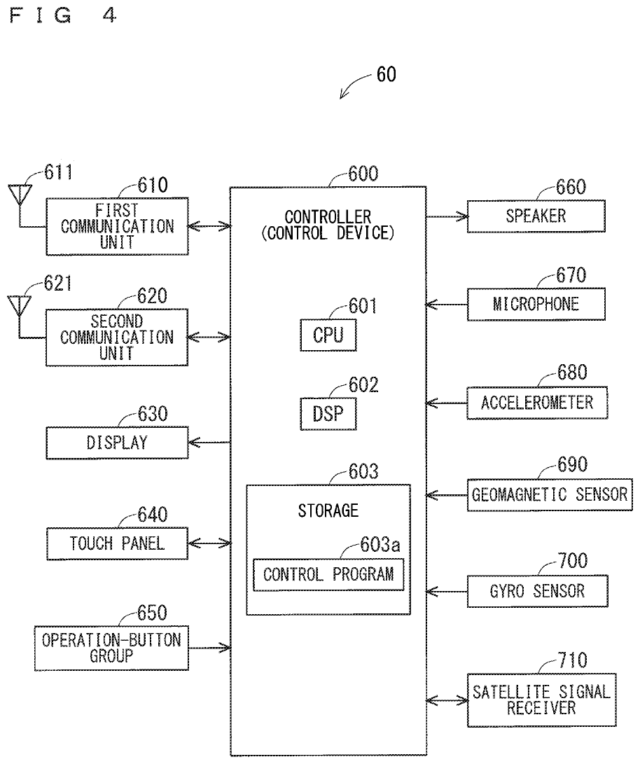

FIG. 4 illustrates one example of a configuration of the on-board device 60. The on-board device 60 is, for example, an electronic device that integrates a car navigation device and an audio device that includes a radio etc. The on-board device 60 may be a car navigation device separate from an audio device, or an audio device separate from a car navigation device. Further, the on-board device 60 may have a vehicle control function of controlling lighting, a direction indicator, etc. of the vehicle 6.

As illustrated in FIG. 4, the on-board device 60 comprises a controller 600, a first communication unit 610, a second communication unit 620, a display 630, a touch panel 640, and an operation-button group 650. Further, the on-board device 60 comprises a speaker 660, a microphone 670, an accelerometer 680, a geomagnetic sensor 690, a gyro sensor 700, and a satellite signal receiver 710. In the description below, unless otherwise noted, reference to a vehicle 6 in description of operation of the on-board device 60 designates a vehicle 6 that is mounted with the on-board device 60. Further, in the description below, unless otherwise noted, reference to a driver in description of operation of the on-board device 60 designates a driver of a vehicle 6 that is mounted with the on-board device 60.

The controller 600 controls other components of the on-board device 60, thereby being capable of integrally managing operation of the on-board device 60. The controller 600 may also be referred to as a control device. The controller 600 comprises at least one processor for providing control and processing capability to perform various functions as described in further detail below. Note that, the configuration of the at least one processor of the controller 600 is the same as the above-mentioned configuration of the at least one processor of the controller 500 of the roadside unit 5, and therefore description thereof is omitted.

In one example, the controller 600 comprises a CPU 601, a DSP 602, and a storage 603. Similarly to the storage 503 of the mobile device 10, the storage 603 comprises a non-transitory recording medium, such as ROM and RAM, that can be read by the CPU 601 and the DSP 602. The storage 603 stores a plurality of control programs 603a etc. for controlling the on-board device 60. The CPU 601 and the DSP 602 execute the various control programs 603a in the storage 603, thereby realizing various functions of the controller 600.

Note that, similarly to the controller 500 of the roadside unit 5, the controller 600 may comprise a plurality of CPUs 601, may omit the DSP 602, or may comprise a plurality of DSPs 602. Further, all of the functions of the controller 600 or a part of the functions of the controller 600 may be realized by a hardware circuit eliminating the necessity of software for realization of the functions of the hardware circuit. Further, similarly to the storage 503 of the roadside unit 5, the storage 603 may comprise a non-transitory recording medium, other than ROM and RAM, that can be read by a computer. Further, at least one control program 603a in the storage 603 may be a control program stored in the storage 603 in advance. Further, at least one control program 603a in the storage 603 may be a control program download by the on-board device 60 from another device and stored in the storage 603.

The first communication unit 610 comprises an antenna 611. The first communication unit 610 may also be referred to as a communication circuit. The antenna 611 is, for example, an omnidirectional antenna. Using the antenna 611, the first communication unit 610 can wirelessly communicate with the roadside unit 5, the on-board device 60 of another vehicle 6, and the electronic device 10. The first communication unit 610 performs 700 MHz band communication, for example.

The first communication unit 610 subjects a signal received at the antenna 611 to various processing treatments such as amplification processing, and then outputs the processed received signal to the controller 600. The controller 600 subjects the input received signal to various processing treatments, thus acquiring information contained in the received signal. Further, the controller 600 outputs a transmission signal containing information to the first communication unit 610. The first communication unit 610 subjects the input transmission signal to various processing treatments such as amplification processing, and then wirelessly transmits the processed transmission signal from the antenna 611.

The second communication unit 620 comprises an antenna 621. The second communication unit 620 may also be referred to as a communication circuit. The antenna 621 is, for example, an omnidirectional antenna. Using the antenna 621, the second communication unit 620 can wirelessly communicate with the roadside unit 5, the on-board device 60 of another vehicle 6, and the electronic device 10. The second communication unit 620 performs wireless LAN communication, for example.

The second communication unit 620 subjects a signal received at the antenna 621 to various processing treatments such as amplification processing, and then outputs the processed received signal to the controller 600. The controller 600 subjects the input received signal to various processing treatments, thus acquiring information contained in the received signal. Further, the controller 600 outputs a transmission signal containing information to the second communication unit 620. The second communication unit 620 subjects the input transmission signal to various processing treatments such as amplification processing, and then wirelessly transmits the processed transmission signal from the antenna 621.

In one example, similarly to the roadside unit 5, a transmission rate of the first communication unit 610 performing 700 MHz band communication is lower than a transmission rate of the second communication unit 620 performing wireless LAN communication.

The display 630 comprises, for example, a liquid crystal display panel or an organic EL panel. With control of the controller 600, the display 630 can display various pieces of information such as characters, symbols, and figures.

The touch panel 640 can detect operation on a display screen of the display 630 input by a pointer such as a finger. The touch panel 640 is, for example, a projected capacitive touch panel. When a user of the on-board device 60 operates a display screen of the display 630 with a pointer such as a finger, the touch panel 640 can input an electric signal corresponding to the operation to the controller 600. The controller 600 can specify the detail of the operation performed on the display screen, based on the electric signal from the touch panel 640. Then, the controller 600 can perform processing corresponding to the specified detail of the operation.

The operation-button group 650 comprises a plurality of operation buttons. Each operation button of the operation-button group 650 is, for example, a hardware button. When the operation button is operated by a user, each operation button can output, to the controller 600, an operation signal indicating that the operation button has been operated. With this, the controller 600 can determine whether or not the operation button has been operated for each of the operation buttons. The controller 600 having received the operation signal controls other components, thereby executing, in the on-board device 60, a function allocated to the operated operation button.

The speaker 660 is, for example, a dynamic speaker. The speaker 660 can convert an electrical audio signal from the controller 600 into sound, and can output the sound thus obtained to the outside of the on-board device 60.

The microphone 670 can detect sound outside of the on-board device 60. The microphone 670 can convert detected sound into an electrical audio signal, and can output the electrical audio signal to the controller 600.

The satellite signal receiver 710 can receive a satellite signal transmitted by a positioning satellite. Then, based on the received satellite signal, the satellite signal receiver 710 can acquire positional information indicating the position of the vehicle 6. The positional information acquired by the satellite signal receiver 710 includes, for example, latitude and longitude indicating the position of the vehicle 6. In the description below, the satellite signal receiver 710 may be simply referred to as the receiver 710.

The receiver 710 is, for example, a GPS receiver, and can receive a wireless signal from a positioning satellite of GPS. The receiver 710 calculates the current position of the vehicle 6 based on the received wireless signal into latitude and longitude, for example, and outputs the positional information containing the calculated latitude and longitude to the controller 600.

Note that, the receiver 710 may acquire positional information of the vehicle 6 based on a signal from a positioning satellite of other global navigation satellite systems (GNSS) than GPS. For example, the receiver 710 may acquire positional information of the vehicle 6 based on a signal from a positioning satellite of the global navigation satellite system (GLONASS), the Indian regional navigational satellite system (IRNSS), COMPASS, Galileo, or the quasi-zenith satellites system (QZSS: quasi-zenith satellites system).

The accelerometer 680 can detect acceleration of the on-board device 60. In other words, the accelerometer 680 can detect acceleration of the vehicle 6. The accelerometer 680 is, for example, a three-axis accelerometer. The geomagnetic sensor 690 is, for example, a three-axis geomagnetic sensor. The geomagnetic sensor 690 can detect the magnetic field in the x-axis direction, the y-axis direction, and the z-axis direction. The gyro sensor 700 is, for example, a three-axis gyro sensor. The gyro sensor 700 can detect angular velocity about each axis of the x-axis, the y-axis, and the z-axis. Based on detection results of the accelerometer 680, the geomagnetic sensor 690, and the gyro sensor 700, the controller 600 can specify a traveling direction of the vehicle 6 etc. Further, based on detection results of the accelerometer 680, the geomagnetic sensor 690, and the gyro sensor 700, the controller 600 can correct positional information acquired by the receiver 710.

Note that, the on-board device 60 may omit at least one sensor out of the accelerometer 680, the geomagnetic sensor 690, and the gyro sensor 700. In this case, the on-board device 60 may be connected, either wirelessly or via a cable, to such separate at least one sensor. Further, the on-board device 60 may comprise a sensor other than the accelerometer 680, the geomagnetic sensor 690, and the gyro sensor 700. In this case, the on-board device 60 may be connected, either wirelessly or via a cable, to a separate sensor other than the accelerometer 680, the geomagnetic sensor 690, and the gyro sensor 700.

In the on-board device 60 having the configuration as above, the first communication unit 610 receives driving safety support information transmitted by the first communication unit 510 of the roadside unit 5. On the other hand, the second communication unit 620 receives an image transmitted by the second communication unit 520 of the roadside unit 5. In the on-board device 60, the controller 600 generates vehicle information of the vehicle 6 based on various pieces of information etc. that are obtained from the accelerometer 680, the geomagnetic sensor 690, the gyro sensor 700, and the satellite signal receiver 710. Based on the generated vehicle information, the driving safety support information from the roadside unit 5, etc., the on-board device 60 issues a notice such as warning to a driver of the vehicle 6. Using the display 630, the speaker 660, or the like, the on-board device 60 can issue a notice such as warning to a driver of the vehicle 6. Further, the controller 600 can also make the display 630 show an image received by the second communication unit 620 from the roadside unit 5.

<Operation Example of Roadside Unit>

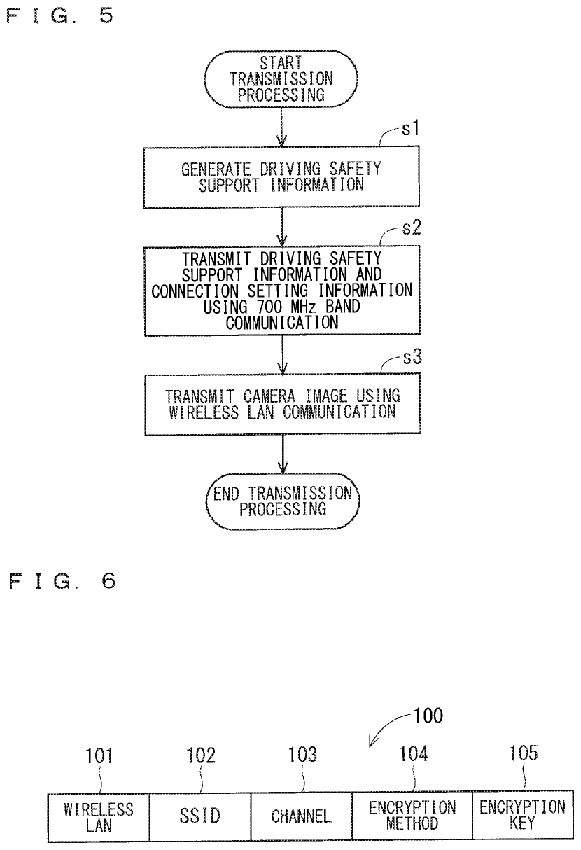

FIG. 5 illustrates a flowchart of one example of transmission processing in the roadside unit 5. The roadside unit 5 repeatedly executes the transmission processing illustrated in FIG. 5. The roadside unit 5 executes the transmission processing every 100 ms, for example.

As illustrated in FIG. 5, in Step s1, the controller 500 generates support information based on detection results of the sensor 540 etc. At this time, if the sensor 540 detects presence of the vehicle 6 at the intersection 2, the controller 500 makes support information include the information of the vehicle 6 detected by the sensor 540. On the other hand, if the sensor 540 does not detect presence of the vehicle 6 at the intersection 2, the controller 500 makes support information include information indicating that no vehicle 6 is present at the intersection 2.

Next, in Step s2, the first communication unit 510 transmits the support information generated in Step s1. At this time, the first communication unit 510 transmits, together with support information, connection setting information necessary for carrying out a connection setting with the second communication unit 520. That is, using the 700 MHz band communication, the roadside unit 5 transmits connection setting information necessary for carrying out a connection setting of wireless LAN communication.

FIG. 6 illustrates one example of connection setting information 100. As illustrated in FIG. 6, the connection setting information 100 includes, for example, type information 101 indicating a type of a wireless communication method of a connection partner, a service set identifier (SSID) 102, channel information 103 indicating a channel (specifically, a wireless channel) to be used, encryption method information 104 indicating an encryption method to be used, an encryption key 105 to be used, etc. The SSID 102 contained in the connection setting information 100 is, for example, an extended SSID (ESSID). Note that, the configuration of the connection setting information 100 is not limited thereto.

Next, in Step s3, the second communication unit 520 transmits a camera image generated in the camera 530. In other words, the roadside unit 5 transmits a camera image using wireless LAN communication. The second communication unit 520 transmits a video generated in the camera 530 for a predetermined period of time, for example. The second communication unit 520 may transmit a camera image using TCP/IP, or may broadcast a camera image using the user datagram protocol (UDP). Note that, TCP stands for Transmission Control Protocol, and IP for Internet Protocol.

The execution of Step s3 brings transmission processing to an end. The roadside unit 5 repeatedly executes such transmission processing as above.

As in the above, using 700 MHz band communication, the roadside unit 5 transmits the connection setting information 100 necessary for carrying out a connection setting of wireless LAN communication. Accordingly, a communication device capable of 700 MHz band communication can receive the connection setting information 100 from the roadside unit 5. Further, in a case where the communication device is capable of wireless LAN communication, the communication device can carry out the connection setting with the second communication unit 520 of the roadside unit 5 using the received connection setting information 100. With this, the communication device can receive a camera image transmitted by the roadside unit 5 using wireless LAN communication.

<Operation Example of On-Board Device>

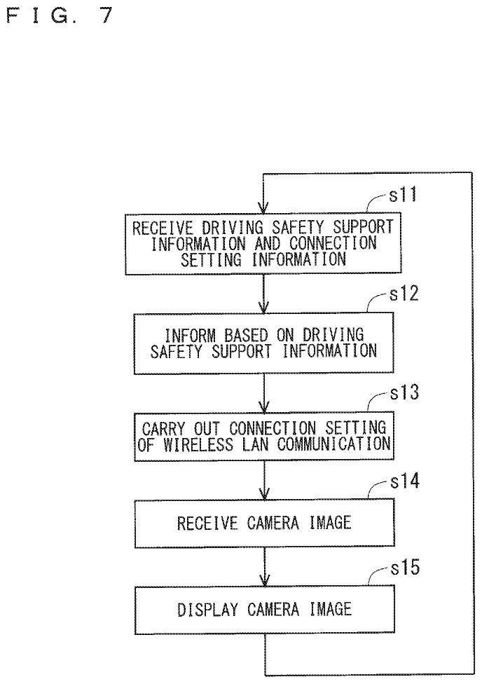

FIG. 7 illustrates a flowchart of one example of operation of the on-board device 60. As illustrated in FIG. 7, when the first communication unit 610 performing 700 MHz band communication receives support information and connection setting information from the roadside unit 5 in Step s11, the on-board device 60 issues a notice such as warning to a driver of the vehicle 6 based on the received support information in Step s12. In the on-board device 60, the controller 600 controls the display 630, the speaker 660, etc. based on the support information, thereby issuing a notice to a driver.

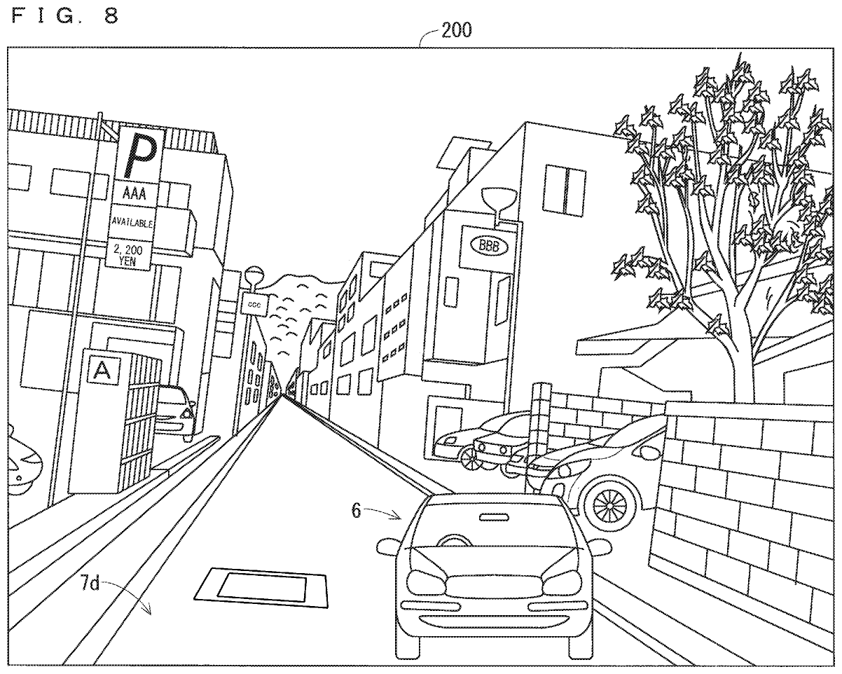

Next, in Step s13, the controller 600 carries out the connection setting of wireless LAN communication based on the connection setting information received in Step s11 so as to enable the second communication unit 620 to communicate with the second communication unit 520 of the roadside unit 5. Next, in Step s14, the second communication unit 620 receives a camera image transmitted by the second communication unit 520 of the roadside unit 5. Then, in Step s15, the controller 600 makes the display 630 show the camera image received in Step s14 for a certain period of time, for example. FIG. 8 illustrates one example of a camera image 200 (i.e., camera image 200 generated by the camera 530 of the roadside unit 5) displayed in the display 630. The camera image 200 illustrated in FIG. 8 captures the vehicle 6 approaching toward the center portion of the intersection 2 from the road 7d.

As in the above, the roadside unit 5 transmits an image showing a state of the road 7, and the on-board device 60 having received the image displays the image. With this, a driver can know a state of the road 7. A driver can know, for example, the position, size, etc. of the vehicle 6 and the pedestrian 9 that are present in the road 7. Thus, driving safety of the vehicle 6 is enhanced.

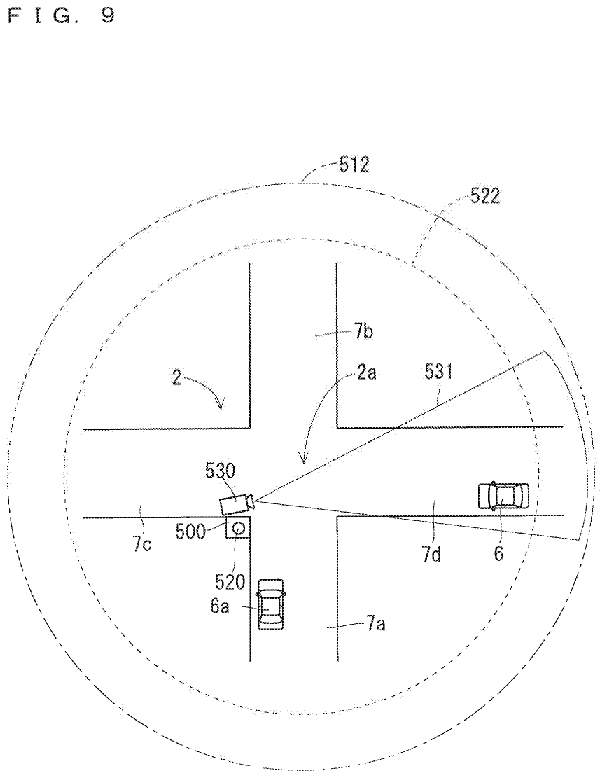

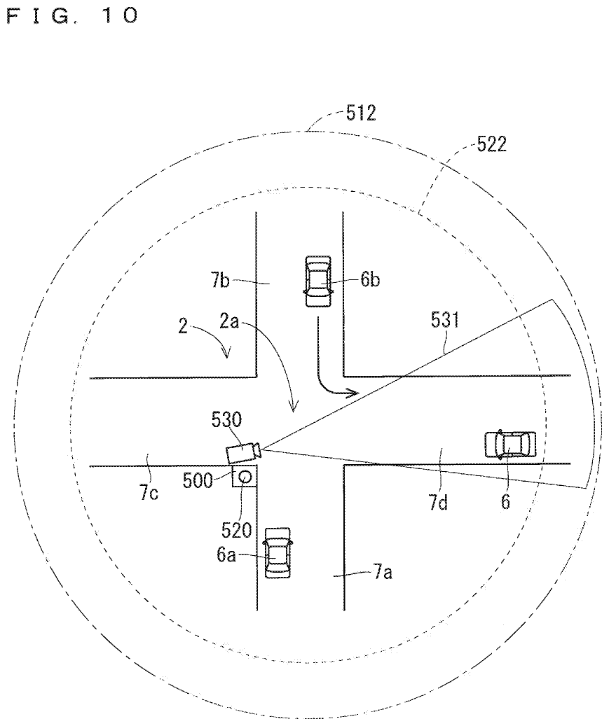

For example, as illustrated in FIG. 9, such a case is assumed that a vehicle 6a approaching toward a center portion 2a of the intersection 2 from the road 7a makes a right turn at the intersection 2. In this case, the on-board device 60 of the vehicle 6a displays an image received from the roadside unit 5. With this, at the time when the vehicle 6a is about to make a right turn, a driver of the vehicle 6a can know a state of the road 7d ahead of the right turn. Thus, a driver of the vehicle 6a can know a state of the road 7d that is difficult to be checked with the eye, which enhances driving safety of the vehicle 6a.

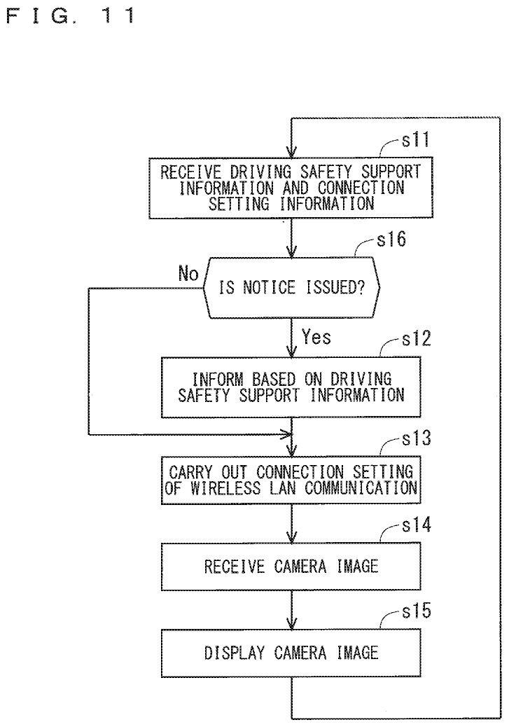

Further, as illustrated in FIG. 10, such a case is assumed that a vehicle 6b approaching toward the center portion 2a of the intersection 2 from the road 7b makes a left turn at the intersection 2. In this case, the on-board device 60 of the vehicle 6b displays an image received from the roadside unit 5. With this, at the time when the vehicle 6b is about to make a left turn, a driver of the vehicle 6b can know a state of the road 7d ahead of the left turn. Thus, a driver of the vehicle 6b can know a state of the road 7d that is difficult to be checked with the eye, which enhances driving safety of the vehicle 6b.

Further, in one example, using 700 MHz band communication, the roadside unit 5 transmits connection setting information of wireless LAN communication. Therefore, a communication device capable of 700 MHz communication can receive connection setting information from the roadside unit 5. On the other hand, it is difficult that a communication device incapable of 700 MHz communication receives connection setting information from the roadside unit 5. Accordingly, it is difficult that a communication device incapable of 700 MHz band communication carries out a connection setting with the second communication unit 520 of the roadside unit 5. That is, it is difficult that a communication device incapable of 700 MHz band communication communicates with the second communication unit 520 of the roadside unit 5. Therefore, it is difficult that a communication device incapable of 700 MHz band communication receives and displays a camera image transmitted by the roadside unit 5. With this, confidentiality of a camera image transmitted by the roadside unit 5 is enhanced.

Note that, in one example of FIG. 5, the roadside unit 5 transmits connection setting information even when the sensor 540 does not detect presence of the vehicle 6 at the intersection 2. In this case, however, connection setting information may not be transmitted. With this, processing in the roadside unit 5 is simplified.

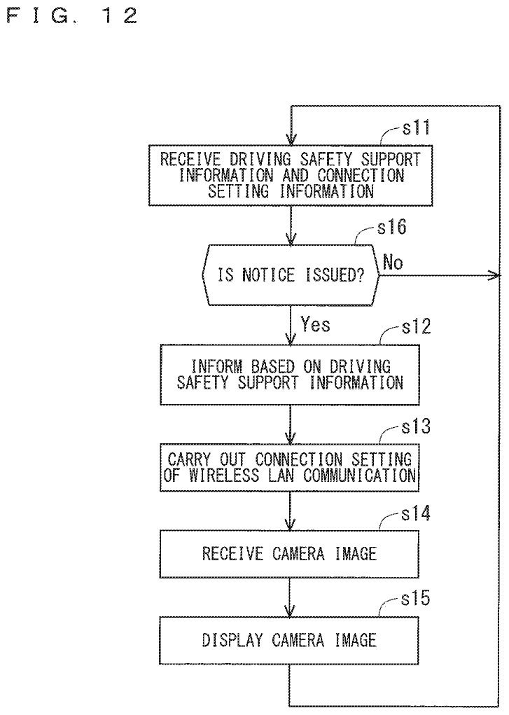

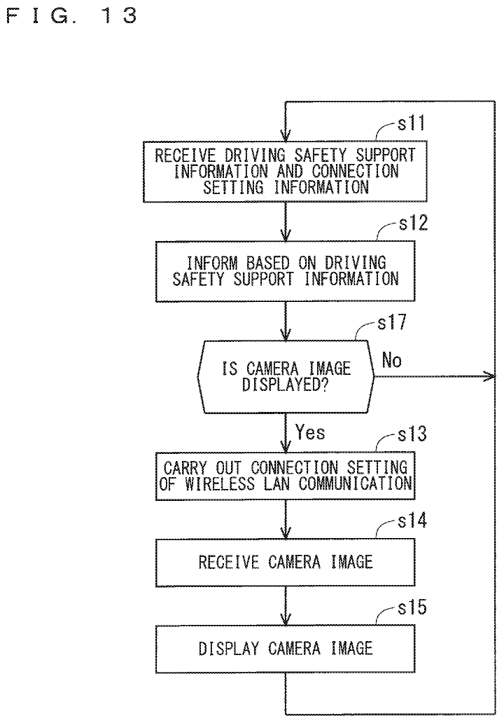

Further, as illustrated in FIG. 11 and FIG. 12, the controller 600 of the on-board device 60 may determine whether or not the on-board device 60 issues a notice to a driver of the vehicle 6 in Step s16 that is executed before Step s12. In this case, if determination is made that the on-board device 60 issues a notice to a driver, the on-board device 60 executes Step s12. On the other hand, if determination is made that the on-board device 60 does not issue a notice to a driver, the on-board device 60 does not execute Step s12. At this time, Steps s13 to s15 may be executed as illustrated in FIG. 11, or may not be executed as illustrated in FIG. 12. The controller 600 determines that the on-board device 60 issues a notice to a driver if, for example, the vehicle 6 makes a right turn and the support information contains information indicating a vehicle is present in a road ahead of the right turn. Further, the controller 600 determines that the on-board device 60 issues a notice to a driver if, for example, the vehicle 6 makes a left turn and the support information contains information indicating a vehicle is present in a road ahead of the left turn. Further, the controller 600 determines that the on-board device 60 does not issue a notice to a driver if, for example, the support information contains information indicating that no vehicle 6 is present at the intersection 2.

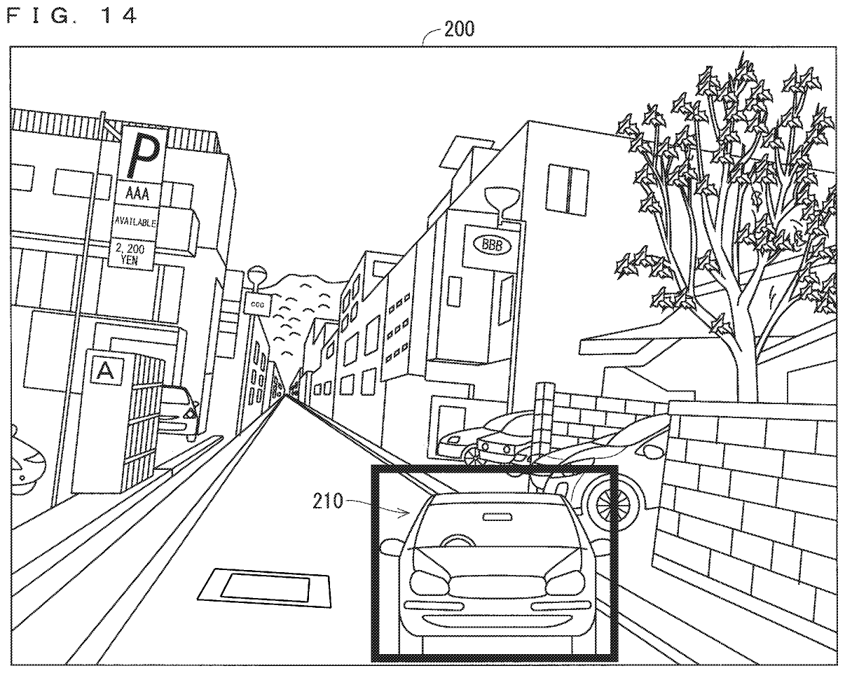

Further, as illustrated in FIG. 13, the controller 600 may determine whether or not the on-board device 60 displays a camera image in Step s17 that is executed before Step s13. In this case, if determination is made that the on-board device 60 displays a camera image, the on-board device 60 executes Steps s13 to s15. On the other hand, if determination is made that the on-board device 60 does not display a camera image, Steps s13 to s15 are not executed.

In Step s17, the controller 600 determines, for example, that the on-board device 60 displays a camera image if the support information contains information indicating that a vehicle is present in the road 7d (refer to FIG. 9 etc.), and determines that the on-board device 60 does not display a camera image if the support information does not contain the information. Further, for example, the controller 600 may determine that the on-board device 60 displays a camera image if the vehicle 6 approaches toward the center portion of the intersection 2 from the road 7a to make a right turn at the intersection 2. Further, for example, the controller 600 may determine that the on-board device 60 displays a camera image if the vehicle 6 approaches toward the center portion of the intersection 2 from the road 7b to make a left turn at the intersection 2. The controller 600 can specify from which road 7 the vehicle 6 approaches toward the center portion of the intersection 2, based on road line shape information contained in the support information, map information described in the storage 603, positional information acquired by the satellite signal receiver 710, etc. Further, the controller 600 may determine that the on-board device 60 displays a camera image if, for example, the vehicle 6 approaches toward the center portion of the intersection 2 from the road 7a to make a right turn at the intersection 2 and the support information contains information indicating that a vehicle is present in the road 7d. Further, the controller 600 may determine that the on-board device 60 displays a camera image if, for example, the vehicle 6 approaches toward the center portion of the intersection 2 from the road 7b to make a left turn at the intersection 2 and the support information contains information indicating that a vehicle is present in the road 7d.

Note that, Step s17 may be executed between Step s13 and Step s14, or may be executed between Step s14 and Step s15. If Step S17 is executed between Step s14 and Step s15, the controller 600 may determine in Step s17 whether or not a vehicle is present in the road 7d based on a camera image received in Step s14. Further, the controller 600 may determine that the on-board device 60 displays a camera image if, for example, the vehicle 6 approaches toward the center portion of the intersection 2 from the road 7a to make a right turn at the intersection 2 and the controller 600 determines that a vehicle is present in the road 7d.

Further, the controller 500 of the roadside unit 5 may subject a camera image to marking processing, where an image of an object detected by the sensor 540 and captured in the camera image is marked. In this case, using wireless LAN communication, the roadside unit 5 transmits the camera image subjected to marking processing. The controller 500 can specify an image of the object detected by the sensor 540 and captured in the camera image based on a detection range of the sensor 540, a capture range of the camera 530, etc. In the description below, such an object may be referred to as an object to be marked.

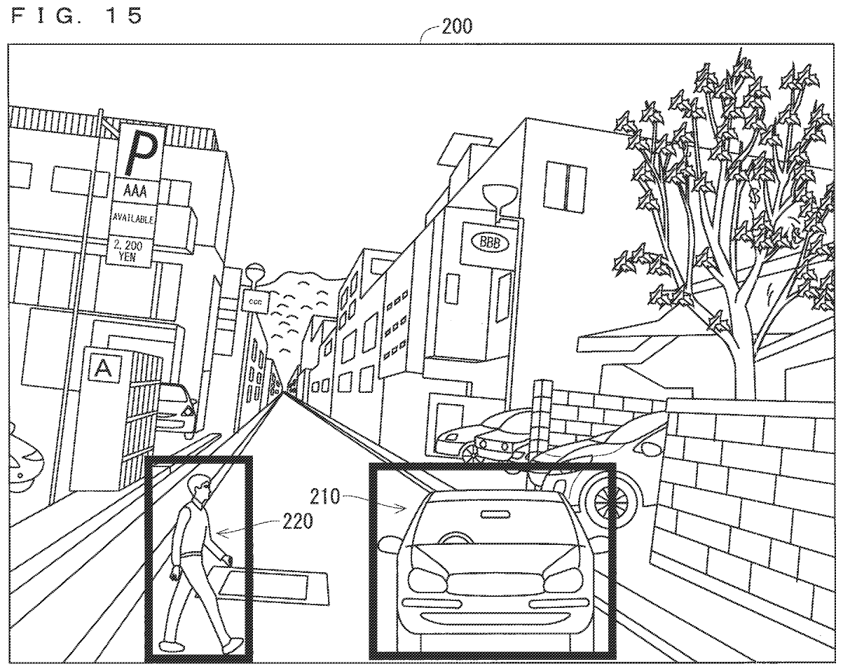

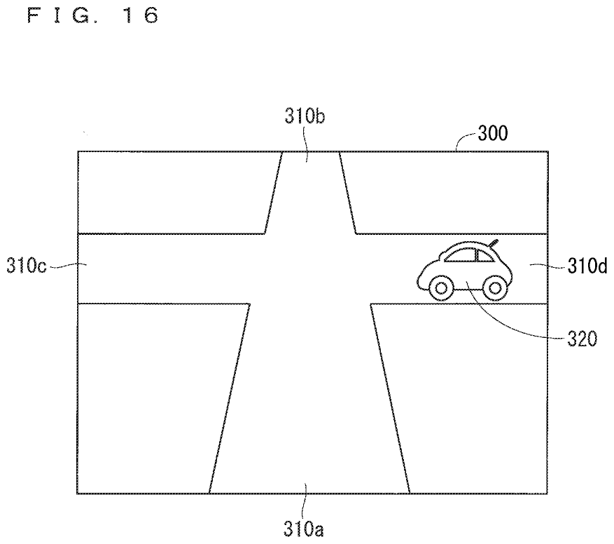

As an object to be marked, for example, the vehicle 6 is conceivable. FIG. 14 illustrates one example of a state in which an image 210 of the vehicle 6 detected by the sensor 540 and captured in the camera image 200 illustrated in FIG. 8 above is marked. In one example of FIG. 14, the image 210 is marked by enclosing the image 210 with a line, but a marking method is not limited thereto. Further, an object to be marked may be the pedestrian 9. Further, objects to be marked may be the vehicle 6 and the pedestrian 9. FIG. 15 illustrates one example of a state in which images 210 and 220 respectively showing the vehicle 6 and the pedestrian 9 that are detected by the sensor 540 and captured in the camera image 200 are marked.

In this manner, in a camera image transmitted by the roadside unit 5, an image of an object detected by the sensor 540 and captured in the camera image is marked. With this, a driver of the vehicle 6 that is mounted with the on-board device 60 and that displays the camera image can more easily specify, within the camera image, an image of an object detected by the roadside unit 5. Thus, a driver can drive with attention to such an object. As a result, driving safety is enhanced.

Note that, through image processing performed on a camera image, the controller 500 can detect the vehicle 6, the pedestrian 9, etc. present in the road 7d (refer to FIG. 9 etc.) within the capture range 531 of the camera 530. Accordingly, it can be said that the camera 530 and the controller 500 serve as a sensor capable of detecting an object present in the road 7d. Such a sensor is referred to as a second sensor. The controller 500 may mark an image of an object detected by the second sensor and captured in a camera image.

Further, an image transmitted by the roadside unit 5 using wireless LAN communication may be an image schematically showing a state of a road as in a computer graphics image (CG), instead of a camera image. In this case, the roadside unit 5 may omit the camera 530.

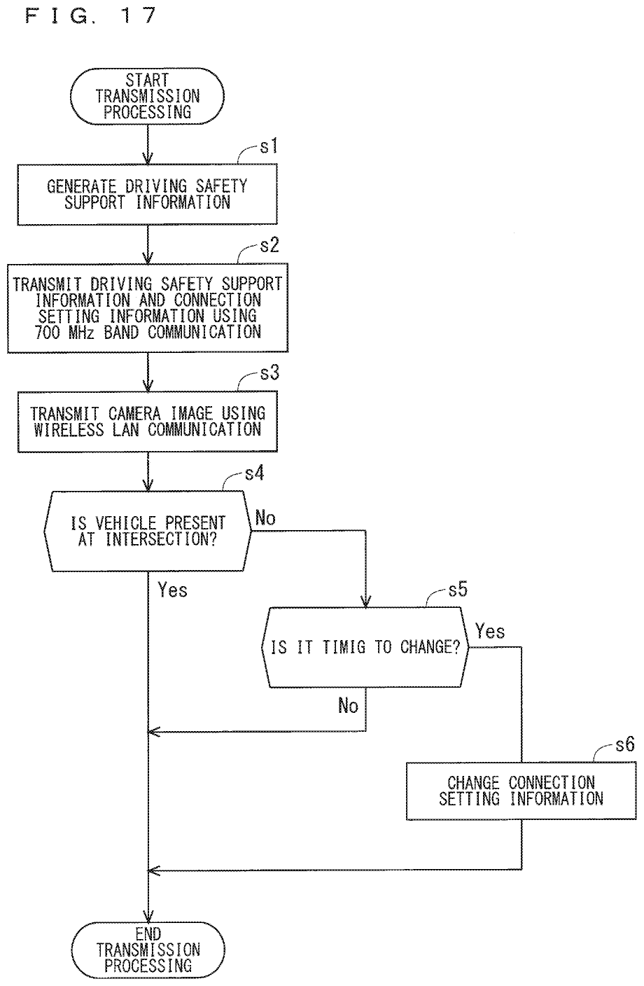

FIG. 16 illustrates one example of an image 300 schematically showing a state of a road transmitted by the roadside unit 5. The image 300 illustrated in FIG. 16 includes images 310a to 310d schematically respectively showing the roads 7a to 7d that are illustrated in FIG. 9. Further, the image 300 includes an image 320 schematically showing the vehicle 6 on the road 7d that is detected by the sensor 540. The image 300 may be an image of a bird's-eye view, or may be another image. Further, the image 300 may include an image schematically showing a utility pole.

### OTHER EXAMPLES

Below is given description of other examples of the communication system 1.

### First Other Example

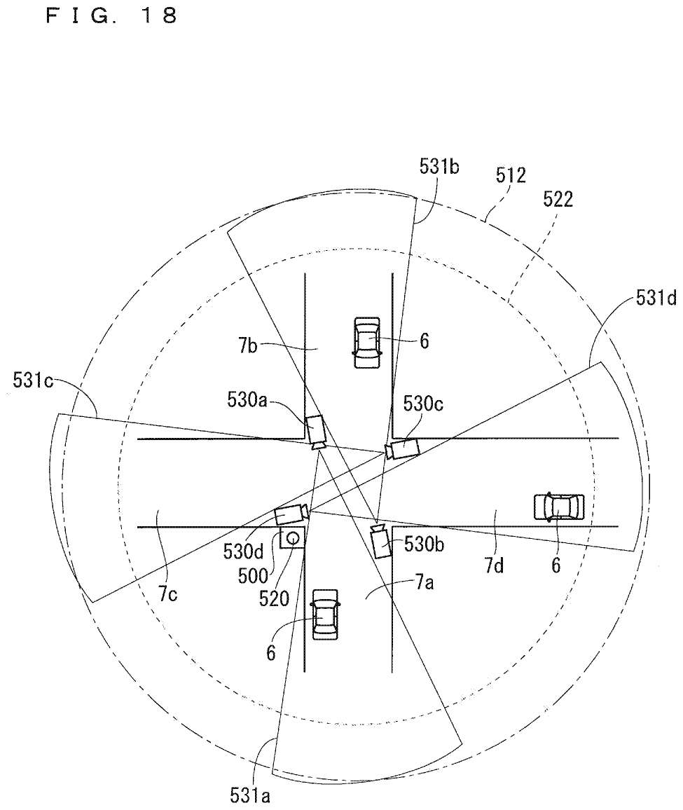

In one example, the controller 500 of the roadside unit 5 can change connection setting information concerning the second communication unit 520. FIG. 17 illustrates a flowchart of one example of transmission processing in the roadside unit 5 according to one example.

As illustrated in FIG. 17, the roadside unit 5 executes Steps s1 to s3 above. Next, the controller 500 determines whether or not the vehicle 6 is present at the intersection 2 based on detection results of the sensor 540. If the sensor 540 detects the vehicle 6, the controller 500 determines that the vehicle 6 is present at the intersection 2. On the other hand, if the sensor 540 does not detect the vehicle 6, the controller 500 determines that no vehicle 6 is present at the intersection 2.

In Step s4, if determination is made that the vehicle 6 is present at the intersection 2, transmission processing ends without changing connection setting information. On the other hand, in Step s4, if determination is made that no vehicle 6 is present at the intersection 2, the controller 500 determines whether or not the present time is the timing to change connection setting information. The controller 500 determines that, for example, the present time is the timing to change connection setting information if a predetermined period of time (e.g. several minutes) has elapsed since the last change of connection setting information. On the other hand, the controller 500 determines that the present time is not the timing to change connection setting information if a predetermined period of time has not yet elapsed since the last change of connection setting information.

In Step s5, if determination is made that the present time is not the timing to change connection setting information, transmission processing ends without changing connection setting information. On the other hand, in Step s5, if determination is made that the present time is the timing to change connection setting information, the controller 500 changes connection setting information concerning the second communication unit 520 in Step s6. The controller 500 changes, for example, only an ESSID and an encryption key among pieces of the connection setting information at random. After Step s6, transmission processing ends. In Step s2 of the nest transmission processing, the changed connection setting information is transmitted.

In this manner, in one example, connection setting information is changed. Therefore, even if connection setting information leaks out to a communication device incapable of communication using the 700 MHz band, the possibility that the communication device can communicate with the second communication unit 520 can be reduced. Thus, confidentiality of information transmitted from the second communication unit 520 is further enhanced.

Further, in one example, connection setting information is changed when no vehicle 6 is present at the intersection 2. In other words, connection setting information is changed when the on-board device 60 carrying out a connection setting with the second communication unit 520 based on connection setting information is not present at the intersection 2. Accordingly, the possibility that the on-board device 60 during communication with the second communication unit 520 cannot communicate with the second communication unit 520 can be reduced.

### Second Other Example

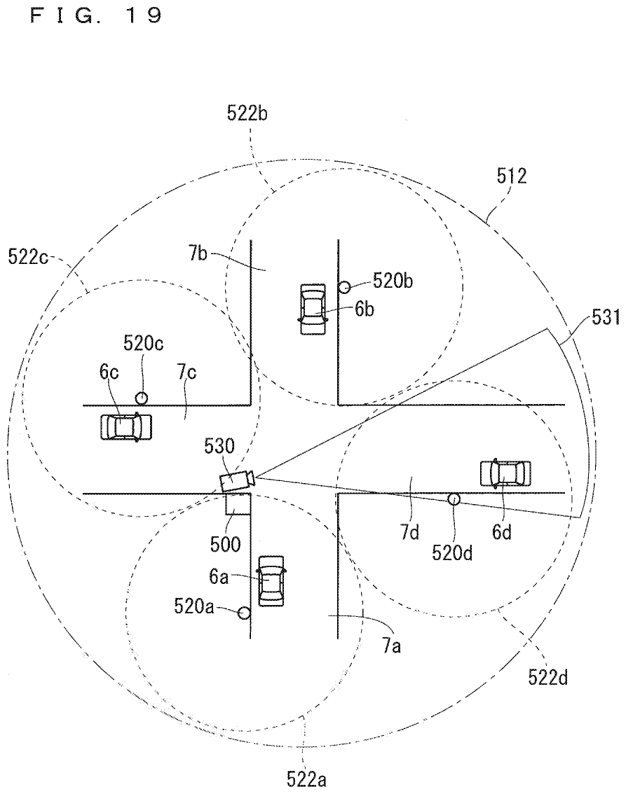

In one example, the roadside unit 5 comprises a plurality of cameras 530. FIG. 18 illustrates one example of capture ranges 531 of the plurality of cameras 530. In one example of FIG. 18, four cameras 530a to 530d are provided in the roadside unit 5. A capture range 531a of the camera 530a covers the road 7a, and a capture range 531b of the camera 530b covers the road 7b. A capture range 531c of the camera 530c covers the road 7c, and a capture range 531d of the camera 530d covers the road 7d. The cameras 530a to 530d generate a camera image showing a state of the roads 7a to 7d, respectively.

In one example, in Step s3 above, the roadside unit 5 makes the second communication unit 520 transmit the plurality of camera images generated in respective cameras 530a to 530d. The on-board device 60 receives the plurality of camera images from the roadside unit 5 in Step s14 above, and makes the display 630 show the received plurality of camera images in Step s15. With this, a driver of the vehicle 6 can check a state of each of the plurality of roads 7a to 7d connected at the intersection 2.

Note that, in a case where no vehicle 6 is present on the road 7a, the on-board device 60 may not display a camera image generated in the camera 530a that shows a state of the road 7a. In a case where support information from the roadside unit 5 contains information indicating that no vehicle 6 is present on the road 7a, the on-board device 60 can specify that no vehicle 6 is present on the road 7a based on the information. Further, the on-board device 60 can specify that no vehicle 6 is present on the road 7a also by performing image processing on a camera image that is generated in the camera 530a and shows a state of the road 7a. The same holds true for camera images generated in the other cameras 530b to 530d.

### Third Other Example

In one example, the roadside unit 5 comprises a plurality of second communication units 520. FIG. 19 illustrates one example of the communication areas 522 of the plurality of second communication units 520. In one example of FIG. 19, four second communication units 520a to 520d are provided in the roadside unit 5. A communication area 522a of the second communication unit 520a covers the road 7a, and a communication area 522b of the second communication unit 520b covers the road 7b. A communication area 522c of the second communication unit 520c covers the road 7c, and a communication area 522d of the second communication unit 520d covers the road 7d. Below is given description of operation examples of the roadside unit 5 and the on-board device 60 according to one modification.

<Operation Example of Roadside Unit>

In one example, in Step s2, the roadside unit 5 transmits connection setting information concerning each of the plurality of second communication units 520a to 520d. At this time, concerning each connection setting information, the roadside unit 5 transmits the connection setting information and notice information informing that the vehicle 6 approaching toward the center portion of the intersection 2 from a road covered by the communication area 522 of the second communication unit 520 corresponding to the connection setting information uses the connection setting information. After Step s2, in Step s3, the roadside unit 5 makes each of the plurality of second communication units 520a to 520d transmit a camera image generated in the camera 530.

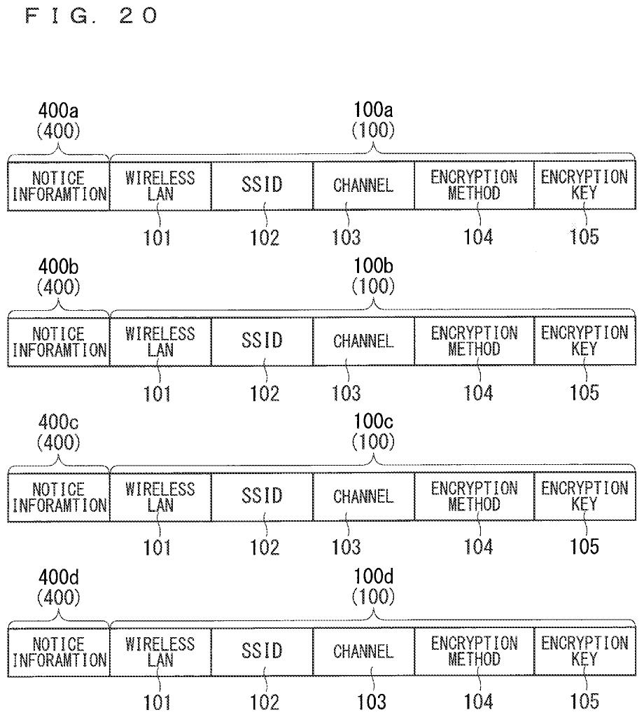

FIG. 20 illustrates one example of pieces of connection setting information 100 and notice information 400 that correspond to the plurality of second communication units 520 of the roadside unit 5. FIG. 20 illustrates connection setting information 100a and notice information 400a that correspond to the second communication unit 520a, connection setting information 100b and notice information 400b that correspond to the second communication unit 520b, connection setting information 100c and notice information 400c that correspond to the second communication unit 520c, and connection setting information 100d and notice information 400d that correspond to the second communication unit 520d.

The notice information 400a is information informing that the vehicle 6a (refer to FIG. 19) approaching toward the center portion of the intersection 2 from the road 7a covered by the communication area 522a of the second communication unit 520a uses the connection setting information 100a concerning the second communication unit 520a. As the notice information 400a, for example, information indicating a traveling direction of the vehicle 6a moving toward the center portion of the intersection 2 from the road 7a is adopted. In FIG. 19, assuming that the upper side as north and the right side as east, a traveling direction of the vehicle 6a moving toward the center portion of the intersection 2 from the road 7a is “north.” In this case, as the notice information 400a, for example, information indicating “north” is adopted. In the description below, for the sake of description, the roads 7a to 7d are assumed to extend in the directions of south, north, west, and east from the center portion of the intersection 2, respectively.

The notice information 400b is information informing that the vehicle 6b (refer to FIG. 19) approaching toward the center portion of the intersection 2 from the road 7b covered by the communication area 522b of the second communication unit 520b uses the connection setting information 100b concerning the second communication unit 520b. As the notice information 400b, for example, information indicating a traveling direction of the vehicle 6b moving toward the center portion of the intersection 2 from the road 7b is adopted. As the notice information 400b, for example, information indicating “south” is adopted.

The notice information 400c is information informing that the vehicle 6c (refer to FIG. 19) approaching toward the center portion of the intersection 2 from the road 7c covered by the communication area 522c of the second communication unit 520c uses the connection setting information 100c concerning the second communication unit 520c. As the notice information 400c, for example, information indicating a traveling direction of the vehicle 6c moving toward the center portion of the intersection 2 from the road 7c is adopted. As the notice information 400c, for example, information indicating “east” is adopted.

The notice information 400d is information informing that the vehicle 6d (refer to FIG. 19) approaching toward the center portion of the intersection 2 from the road 7d covered by the communication area 522d of the second communication unit 520d uses the connection setting information 100d concerning the second communication unit 520d. As the notice information 400d, for example, information indicating a traveling direction of the vehicle 6d moving toward the center portion of the intersection 2 from the road 7d is adopted. As the notice information 400d, for example, information indicating “west” is adopted.

Note that, as the notice information 400, information other than the above example may be adopted. For example, the notice information 400 may be information indicating, using degrees, a traveling direction of the vehicle 6 moving toward the center portion of the intersection 2 from the road 7 covered by the communication area 522 of the second communication unit 520 corresponding to the notice information 400. For example, north, east, south, and west are assumed to be 0 degrees, 90 degrees, 180 degrees, and 270 degrees, respectively. As the pieces of the notice information 400a to 400d, for example, pieces of information indicating 0 degrees, 180 degrees, 90 degrees, and 270 degrees may be adopted, respectively.

<Operation Example of On-Board Device>

In one example, in Step s13, the controller 600 of the on-board device 60 specifies the connection setting information 100 to be used among pieces of information received from the roadside unit 5 in Step s11. In a case where the vehicle 6 travels toward north on the road 7a, i.e., in a case where the vehicle 6 approaches toward the center portion of the intersection 2 from the road 7a, the controller 600 determines the connection setting information 100a that corresponds to the notice information 400a indicating “north” as the connection setting information 100 to be used. The controller 600 can specify, for example, a road in which the vehicle 6 travels and a traveling direction of the vehicle 6 based on road line shape information contained in the support information from the roadside unit 5, map information in the storage 603, and positional information acquired by the receiver 710.

In a case where the vehicle 6 travels toward south on the road 7b, i.e., in a case where the vehicle 6 approaches toward the center portion of the intersection 2 from the road 7b, the controller 600 determines the connection setting information 100b that corresponds to the notice information 400b indicating “south” as the connection setting information 100 to be used. In a case where the vehicle 6 travels toward east on the road 7c, i.e., in a case where the vehicle 6 approaches toward the center portion of the intersection 2 from the road 7c, the controller 600 determines the connection setting information 100c that corresponds to the notice information 400c indicating “east” as the connection setting information 100 to be used. In a case where the vehicle 6 travels toward west on the road 7d, i.e., in a case where the vehicle 6 approaches toward the center portion of the intersection 2 from the road 7d, the controller 600 determines the connection setting information 100d that corresponds to the notice information 400d indicating “west” as the connection setting information 100 to be used.

After specifying the connection setting information 100 to be used, the controller 600 carries out a connection setting of wireless LAN communication based on the connection setting information 100 to be used. With this, the second communication unit 620 of the on-board device 60 can communicate with the second communication unit 520 of the roadside unit 5 that corresponds to the connection setting information 100 to be used. In the description below, the second communication unit 520 that corresponds to the connection setting information 100 to be used may be referred to as the second communication unit 520 to be communicated.

After carrying out the connection setting of wireless LAN communication, in Step s14, the second communication unit 620 receives an image transmitted by the second communication unit 520 to be communicated. Then, in Step s15, the controller 600 makes the display 630 show the image received in Step s14 for a certain period of time.

Note that, in Step s13, in a case where the vehicle 6 moves away from the center portion of the intersection 2, the controller 600 does not specify the connection setting information 100c to be used. In this case, Steps s13 and s14 are not executed.

As in the above, even in a case where the plurality of roads 7 connected at the intersection 2 are covered by the communication areas 522 of the plurality of second communication units 520, the roadside unit 5 informs the on-board device 60 about a piece of connection setting information to be used by the on-board device 60 among pieces of the connection setting information of the plurality of second communication units 520. With this, the on-board device 60 can properly receive information transmitted by the roadside unit 5 using wireless LAN communication.

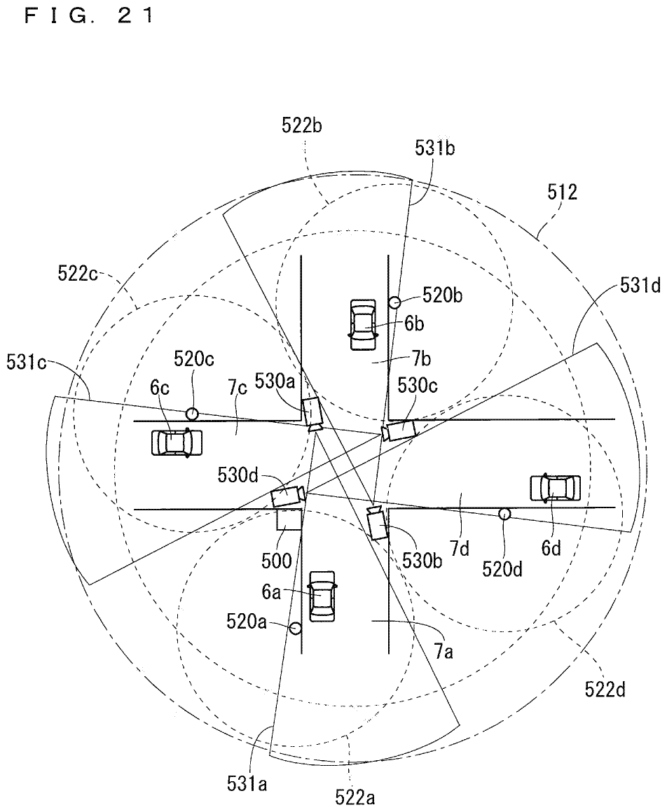

Note that, in one example, the roadside unit 5 may also comprise a plurality of cameras 530 as in the above second other example. FIG. 21 illustrates a state in which the plurality of cameras 530a to 530d illustrated in FIG. 18 above are provided in the roadside unit 5 according to one example.

In one example of FIG. 21, in Step s3, for example, the roadside unit 5 makes each of the plurality of second communication units 520 transmit a plurality of camera images generated in a respective plurality of cameras 530a to 530d. In this case, for example, the on-board device 60 may make the display 630 show all of the plurality of images received from the second communication unit 520 to be communicated. With this, a driver of the vehicle 6 approaching toward the center portion of the intersection 2 can know a state of each road 7 at the intersection 2. Further, for example, in a case where no vehicle 6 is present on the road 7a, the on-board device 60 may not display an image showing a state of the road 7a (i.e., image generated in the camera 530a) among the plurality of received images. The same holds true for images showing other roads. With this, the possibility that images that may not be very important to a driver of the vehicle 6 are displayed in the on-board device 60 can be reduced.

Further, in one example of FIG. 21, the second communication unit 520 may transmit, without transmitting an image showing a state of the road 7 covered by its own communication area 522, an image showing a state of another road 7 different from the road 7. For example, the second communication unit 520a may transmit, without transmitting an image showing a state of the road 7a covered by its own communication area 522a (i.e., image generated in the camera 530a), images showing states of the roads 7b to 7d (i.e., images generated in the cameras 530b to 530d). At this time, the second communication unit 520a may not transmit an image showing the road 7 in which no vehicle 6 is present among images showing states of the roads 7b to 7d. The roadside unit 5 can specify the road 7 in which no vehicle 6 is present based on detection results of the sensor 540. Further, the roadside unit 5 can specify the road 7 in which no vehicle 6 is present based even on images generated in the cameras 530a to 530d.

Further, the second communication unit 520b may transmit, without transmitting an image showing a state of the road 7b covered by its own communication area 522b (i.e., image generated in the camera 530b), images showing states of the roads 7a, 7c, and 7d (i.e., images generated in the cameras 530a, 530c, and 530d). At this time, the second communication unit 520b may not transmit an image showing the road 7 in which no vehicle 6 is present among images showing states of the roads 7a, 7c, and 7d. The same holds true for the second communication units 520c and 520d.

Further, in a case where the second communication unit 520a transmits images showing states of the roads 7b to 7d without transmitting an image showing a state of the road 7a, the first communication unit 510 may not transmit connection setting information of the second communication unit 520a when no vehicle 6 is present in the roads 7b to 7d. Further, in a case where the second communication unit 520b transmits images showing states of the roads 7a, 7c, and 7d without transmitting an image showing a state of the road 7b, the first communication unit 510 may not transmit connection setting information of the second communication unit 520b when no vehicle 6 is present in the roads 7a, 7c, and 7d. The same holds true for the second communication units 520c and 520d.

Further, a driver of the vehicle 6 approaching toward the center portion of the intersection 2 from the road 7a can easily check with the eye a state of the road 7b extending along the same direction as that of the road 7a. Accordingly, the second communication unit 520a may not transmit an image showing a state of the road 7b as well as an image showing a state of the road 7a. In this case, the first communication unit 510 may not transmit connection setting information of the second communication unit 520a when no vehicle 6 is present in the roads 7c and 7d. Similarly, the second communication unit 520c may not transmit an image showing a state of the road 7d as well as an image showing a state of the road 7c. In this case, the first communication unit 510 may not transmit connection setting information of the second communication unit 520c when no vehicle 6 is present in the roads 7a and 7b. The same holds true for the second communication units 520b and 520d.

### Fourth Other Example

The communication system 1 according to one example is a communication system obtained by changing the communication system 1 according to the above second other example (refer to FIG. 18). Below is given description of operation examples of the roadside unit 5 and the on-board device 60 according to one example.

<Operation Example of Roadside Unit>

In one example, the second communication unit 520 of the roadside unit 5 can communicate using a plurality of channels (specifically, a plurality of wireless channels). The second communication unit 520 can perform wireless LAN communication using two channels, for example.

Here, IEEE802.11g provides 1st to 13th channels. In a case where the second communication unit 520 communicates in conformity with IEEE802.11g, for example, 1st and 13th channels that do not overlap in channel bandwidth with each other are used in the second communication unit 520. With this, the second communication unit 520 can communicate using two channels at one time. In the description below, the two channels used in the second communication unit 520 may be referred to as first and second channels.

In one example, in Step s2, the first communication unit 510 of the roadside unit 5 transmits first connection setting information necessary for a connection setting of the first channel used by the second communication unit 520 and second connection setting information necessary for a connection setting of the second channel used by the second communication unit 520. At this time, the first communication unit 510 transmits the first connection setting information and first notice information informing that the vehicle 6 approaching toward the center portion of the intersection 2 from a first road among the roads 7a to 7d uses the first connection setting information. Further, the first communication unit 510 transmits the second connection setting information and second notice information informing that the vehicle 6 approaching toward the center portion of the intersection 2 from a second road among the roads 7a to 7d uses the second connection setting information.

The first road is, for example, the roads 7a and 7b. Accordingly, the first notice information is information informing that the vehicle 6 approaching toward the center portion of the intersection 2 from the road 7a and the vehicle 6 approaching toward the center portion of the intersection 2 from the road 7b use the first connection setting information. The second road is, for example, the roads 7c and 7d. Accordingly, the second notice information is information informing that the vehicle 6 approaching toward the center portion of the intersection 2 from the road 7c and the vehicle 6 approaching toward the center portion of the intersection 2 from the road 7d use the second connection setting information.

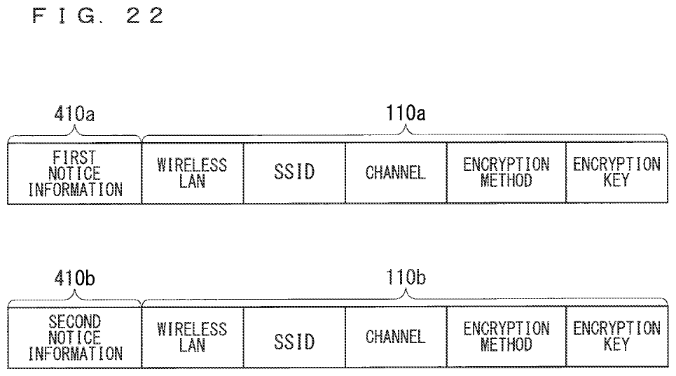

FIG. 22 illustrates one example of first connection setting information 110a and first notice information 410a, and second connection setting information 110b and second notice information 410b. The configuration of the first connection setting information 110a and the second connection setting information 110b is similar to the configuration of the connection setting information 100 illustrated in FIG. 6 etc. above.

As the first notice information 410a, for example, information indicating a traveling direction of the vehicle 6 moving toward the center portion of the intersection 2 from the road 7a and a traveling direction of the vehicle 6 moving toward the center portion of the intersection 2 from the road 7b is adopted. As the first notice information 410a, for example, information indicating “north and south” is adopted. A specific example of the first notice information 410a is not limited thereto.

As the second notice information 410b, for example, information indicating a traveling direction of the vehicle 6 moving toward the center portion of the intersection 2 from the road 7c and a traveling direction of the vehicle 6 moving toward the center portion of the intersection 2 from the road 7d is adopted. As the second notice information 410b, for example, information indicating “east and west” is adopted. A specific example of the second notice information 410b is not limited thereto.

In Step s3, the second communication unit 520 transmits, using the first channel, an image showing a state of a third road different from the first road without transmitting an image showing a state of the first road, for example. The third road is, for example, the roads 7c and 7d. Accordingly, the second communication unit 520 transmits, using the first channel, images showing states of the roads 7c and 7d without transmitting images showing states of the roads 7a and 7b.

Further, in Step s3, the second communication unit 520 transmits, using the second channel, an image showing a state of a fourth road different from the second road without transmitting an image showing a state of the second road, for example. The fourth road is, for example, the roads 7a and 7b. Accordingly, the second communication unit 520 transmits, using the second channel, images showing states of the roads 7a and 7b without transmitting images showing states of the roads 7c and 7d.

<Operation Example of On-Board Device>

In one example, in Step s13, the controller 600 of the on-board device 60 specifies connection setting information to be used among the pieces of the first and second connection setting information received from the roadside unit 5 in Step s11. In a case where the vehicle 6 travels toward north on the road 7a, i.e., in a case where the vehicle 6 approaches toward the center portion of the intersection 2 from the road 7a, the controller 600 determines the first connection setting information 110a that corresponds to the notice information 410a indicating “north and south” as the connection setting information to be used. Further, in a case where the vehicle 6 travels toward south on the road 7b, i.e., in a case where the vehicle 6 approaches toward the center portion of the intersection 2 from the road 7b, the controller 600 determines the first connection setting information 110a that is informed of by the notice information 410a indicating “north and south” as the connection setting information to be used.

On the other hand, in a case where the vehicle 6 travels toward east on the road 7c, i.e., in a case where the vehicle 6 approaches toward the center portion of the intersection 2 from the road 7c, the controller 600 determines the second connection setting information 110b that is informed of by the notice information 410b indicating “east and west” as the connection setting information to be used. Further, in a case where the vehicle 6 travels toward west on the road 7d, i.e., in a case where the vehicle 6 approaches toward the center portion of the intersection 2 from the road 7d, the controller 600 determines the second connection setting information 110b that is informed of by the notice information 410b indicating “east and west” as the connection setting information to be used.

In Step s13, after specifying the connection setting information to be used, the controller 600 carries out a connection setting of wireless LAN communication based on the connection setting information to be used. With this, in a case where the connection setting information to be used is the first connection setting information 110a, the second communication unit 620 of the on-board device 60 can communicate with the second communication unit 520 of the roadside unit 5 using the first channel. Further, in a case where the connection setting information to be used is the second connection setting information 110b, the second communication unit 620 of the on-board device 60 can communicate with the second communication unit 520 of the roadside unit 5 using the second channel. In the description below, a channel to be used by the second communication unit 620 may be referred to as a channel to be used.

After carrying out the connection setting of wireless LAN communication based on the connection setting information to be used, in Step s14, the second communication unit 620 receives an image transmitted from the roadside unit 5 using a channel to be used. Then, in Step s15, the display 630 shows the image received in Step s14.

In a case where the channel to be used is the first channel, in Step s14, the second communication unit 620 receives an image showing a state of the road 7c (i.e., image generated in the camera 530c) and an image showing a state of the road 7d (i.e., image generated in the camera 530d). On the other hand, in a case where the channel to be used is the second channel, in Step s14, the second communication unit 620 receives an image showing a state of the road 7a (i.e., image generated in the camera 530a) and an image showing a state of the road 7b (i.e., image generated in the camera 530b).

With the operation of the roadside unit 5 and the on-board device 60 as in the above, the on-board device 60 of the vehicle 6 approaching toward the center portion of the intersection 2 from the road 7a displays an image showing a state of the road 7c and an image showing a state of the road 7d. Accordingly, a driver of the vehicle 6 approaching toward the center portion of the intersection 2 from the road 7a can check, through the displayed images, states of the roads 7c and 7d that are difficult to be checked with the eye.

Similarly, the on-board device 60 of the vehicle 6 approaching toward the center portion of the intersection 2 from the road 7b displays an image showing a state of the road 7c and an image showing a state of the road 7d. Accordingly, a driver of the vehicle 6 approaching toward the center portion of the intersection 2 from the road 7b can check, through the displayed images, states of the roads 7c and 7d that are difficult to be checked with the eye.

Further, the on-board device 60 of the vehicle 6 approaching toward the center portion of the intersection 2 from the road 7c displays an image showing a state of the road 7a and an image showing a state of the road 7b. Accordingly, a driver of the vehicle 6 approaching toward the center portion of the intersection 2 from the road 7c can check, through the displayed images, states of the roads 7a and 7b that are difficult to be checked with the eye.

Similarly, the on-board device 60 of the vehicle 6 approaching toward the center portion of the intersection 2 from the road 7d displays an image showing a state of the road 7a and an image showing a state of the road 7b. Accordingly, a driver of the vehicle 6 approaching toward the center portion of the intersection 2 from the road 7d can check, through the displayed images, states of the roads 7a and 7b that are difficult to be checked with the eye.

Note that, the second communication unit 520 may not transmit an image showing the road 7 in which no vehicle 6 is present among images to be transmitted using the first channel, i.e., among images showing states of the roads 7c and 7d.

Further, the second communication unit 520 may not transmit an image showing the road 7 in which no vehicle 6 is present among images to be transmitted using the second channel, i.e., among images showing states of the roads 7a and 7b.

Further, the first communication unit 510 may not transmit the first connection setting information 110a of the first channel in a case where no vehicle 6 is present on the roads 7c and 7d. In this case, the first communication unit 510 transmits the first connection setting information 110a in a case where the vehicle 6 is present on at least one road of the roads 7c and 7d.

Further, the first communication unit 510 may not transmit the second connection setting information 110b of the second channel in a case where no vehicle 6 is present on the roads 7a and 7b. In this case, the first communication unit 510 transmits the second connection setting information 110b in a case where the vehicle 6 is present on at least one road of the roads 7a and 7b.

### Fifth Other Example

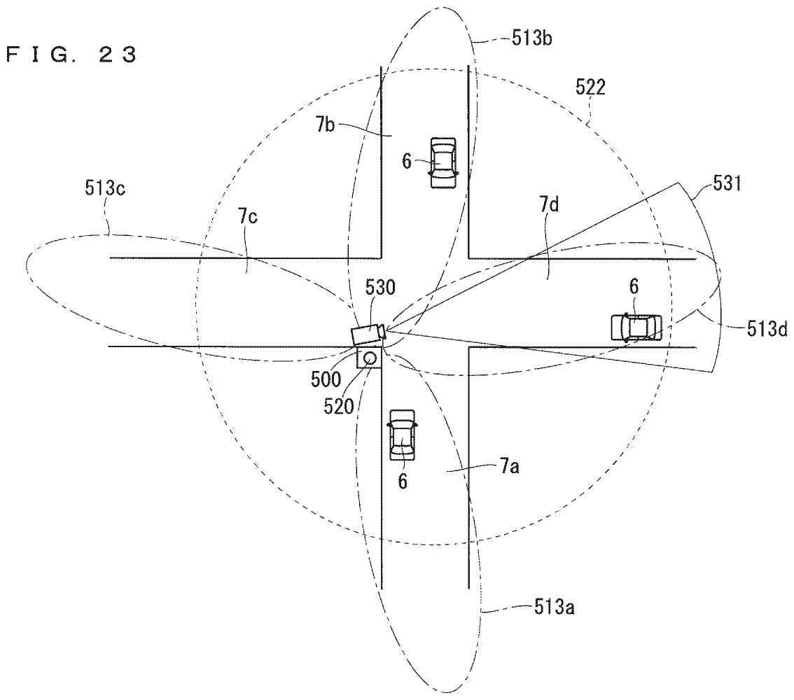

In one example, the antenna 511 of the first communication unit 510 of the roadside unit 5 is a directional antenna. FIG. 23 illustrates one example of directivity of the antenna 511.

As illustrated in FIG. 23, directivity of the antenna 511 has, for example, four fixed beams 513a to 513d. The beams 513a to 513d extend along the roads 7a to 7d, respectively. The antenna 511 comprises, for example, a plurality of antenna elements. Through adjustment of a relative positional relationship between the plurality of antenna elements, the plurality of beams 513a to 513d can be formed in the directivity of the antenna 511.

The first communication unit 510 can transmit different pieces of information from the beams 513a to 513d. With this, the first communication unit 510 can transmit different pieces of information toward the roads 7a to 7d. In other words, the first communication unit 510 can transmit different pieces of information to the vehicles 6 traveling in the roads 7a to 7d.

In one example, in Step s2, the first communication unit 510 transmits support information from each of the beams 513a to 513d. On the other hand, in Step s2, the first communication unit 510 transmits connection setting information only from a part of the beams 513a to 513d. For example, the first communication unit 510 transmits connection setting information from the beam 513a, and does not transmit connection setting information from the beams 513b to 513d. The beam 513a extends along the road 7a, and therefore the vehicle 6 on the road 7a can receive connection setting information from the roadside unit 5. On the other hand, it is difficult that the vehicle 6 on the roads 7b to 7d receives connection setting information from the roadside unit 5.

The on-board device 60 that receives support information and does not receive connection setting information in Step s11 executes Step s12, and does not execute Steps s13 to 15. On the other hand, the on-board device 60 that receives support information and connection setting information in Step s11 executes Steps s12 to s15. With this, a driver of the vehicle 6 approaching toward the center portion of the intersection 2 from the road 7a can know, through an image displayed in the on-board device 60, a state of the road 7d that is difficult to be checked with the eye.

Note that, the first communication unit 510 may transmit connection setting information from the beams 513a and 513b, and may not transmit connection setting information from the beams 513c to 513d. In this case, a driver of the vehicle 6 approaching toward the center portion of the intersection 2 from the road 7b can also know a state of the road 7d through an image displayed in the on-board device 60.

As in the above, in one example, the first communication unit 510 of the roadside unit 5 transmits information from a beam extending along a road, and therefore the possibility that the information is received by a device other than a device that is present in the road can be reduced. Thus, the possibility that information is received by a device that does not require information transmitted by a roadside unit can be reduced.

Further, in one example, the first communication unit 510 transmits connection setting information only from a part of a plurality of beams extending along a respective plurality of roads, and can therefore properly transmit connection setting information to a device that requires an image from the roadside unit 5.

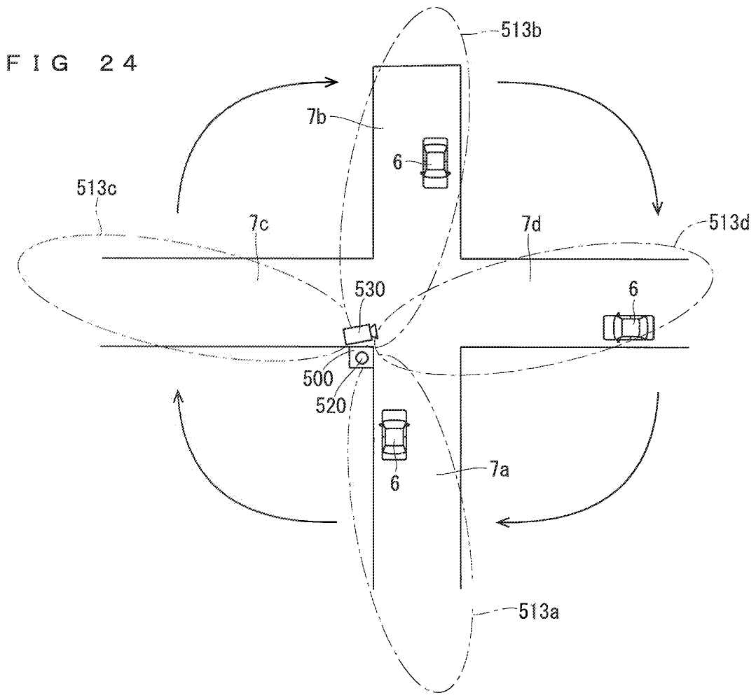

Note that, the first communication unit 510 may generate the beams 513a to 513d by sequentially switching directions of the beam as illustrated in FIG. 24, using the adaptive array technology or the like. In this case, in Step s2, for example, the first communication unit 510 transmits support information and connection setting information from the beam 513a, and then transmits support information from the beam 513c. After that, the first communication unit 510 transmits support information from the beam 513b, and then transmits support information from the beam 513d. A setting order of the beams 513a to 513d may be an order reverse to the order illustrated in FIG. 24, and may be an order other than a clockwise direction and a counterclockwise direction.

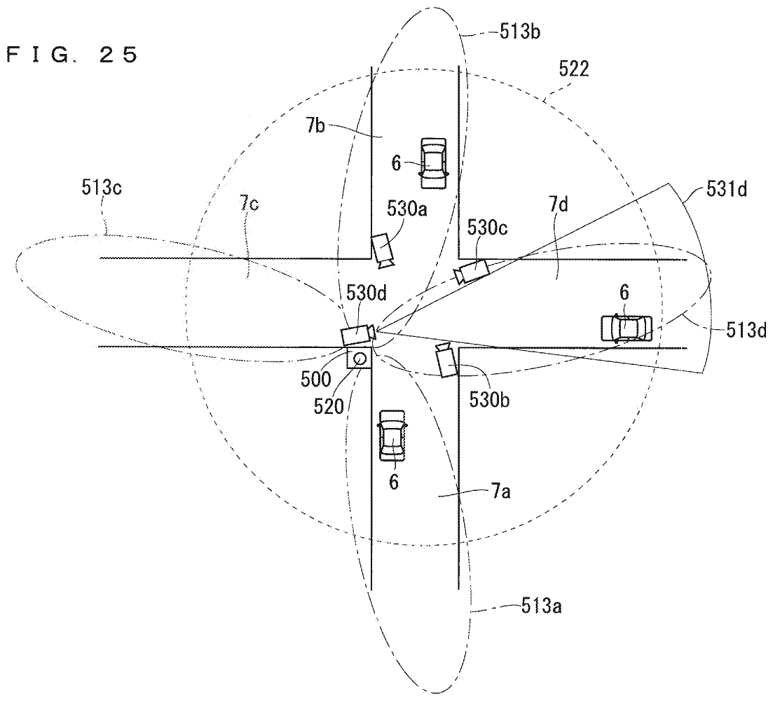

Further, as in the second other example, the roadside unit 5 according to one example may comprise a plurality of cameras 530. FIG. 25 illustrates one example of a state in which the roadside unit 5 according to one example comprises the plurality of cameras 530a to 530d. In one example of FIG. 25, for example, the second communication unit 520 of the roadside unit 5 transmits images generated in the plurality of cameras 530a to 530d.

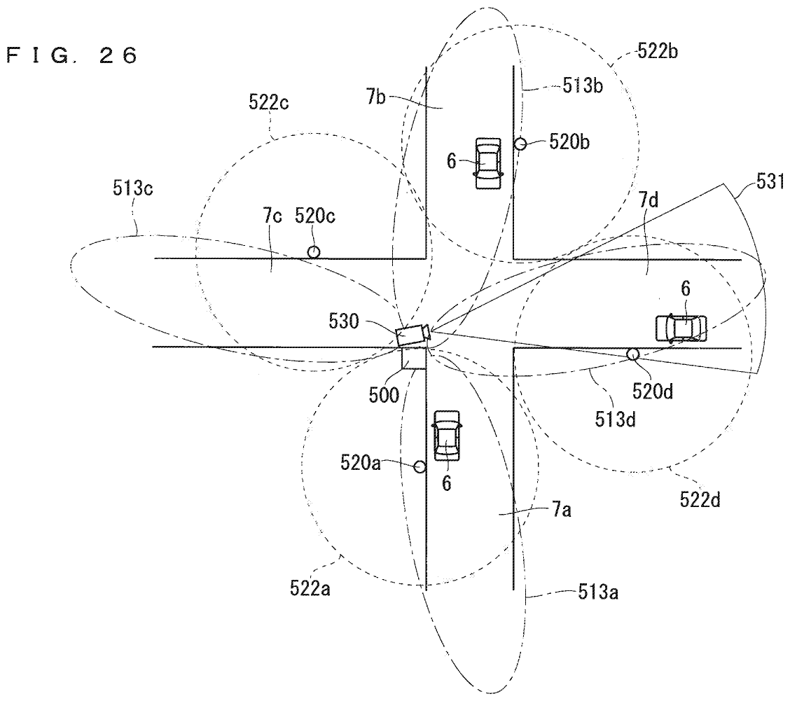

Further, as in the third other example, the roadside unit 5 according to one example may comprise a plurality of second communication units 520. FIG. 26 illustrates one example of a state in which the roadside unit 5 according to one example comprises the plurality of second communication units 520a to 520d.

In one example of FIG. 26, concerning each of the plurality of beams 513a to 513d, the first communication unit 510 of the roadside unit 5 transmits, from each corresponding beam, only connection setting information of a second communication unit 520 out of connection setting information of the plurality of second communication units 520a to 520d, for example. The communication area 522 of the second communication unit 520 covers a road along which the corresponding beam extends. Specifically, the first communication unit 510 transmits, from the beam 513a, only connection setting information of the second communication unit 520a out of connection setting information of the plurality of communication units 520a to 520d. The communication area 522a of the second communication unit 520a covers the road 7a along which the beam 513a extends. Further, the first communication unit 510 transmits, from the beam 513b, only connection setting information of the second communication unit 520b out of connection setting information of the plurality of communication units 520a to 520d. The communication area 522b of the second communication unit 520b covers the road 7b along which the beam 513b extends. Further, the first communication unit 510 transmits, from the beam 513c, only connection setting information of the second communication unit 520c out of connection setting information of the plurality of communication units 520a to 520d. The communication area 522c of the second communication unit 520c covers the road 7c along which the beam 513c extends. Further, the first communication unit 510 transmits, from the beam 513d, only connection setting information of the second communication unit 520d out of connection setting information of the plurality of communication units 520a to 520d. The communication area 522d of the second communication unit 520d covers the road 7d along which the beam 513d extends. Further, in one example of FIG. 26, each of the second communication units 520a to 520d transmits an image generated in the camera 530.

In one example of FIG. 26, using 700 MHz band communication, the on-board device 60 of the vehicle 6 on the road 7a receives connection setting information of the second communication unit 520a from the roadside unit 5. With this, using wireless LAN communication, the on-board device 60 of the vehicle 6 on the road 7a can receive and display an image transmitted from the second communication unit 520a. Similarly, using 700 MHz band communication, the on-board device 60 of the vehicle 6 on the road 7b receives connection setting information of the second communication unit 520b from the roadside unit 5. With this, using wireless LAN communication, the on-board device 60 of the vehicle 6 on the road 7b can receive and display an image transmitted from the second communication unit 520b. The same holds true for the on-board device 60 of the vehicle 6 on the roads 7c and 7d.

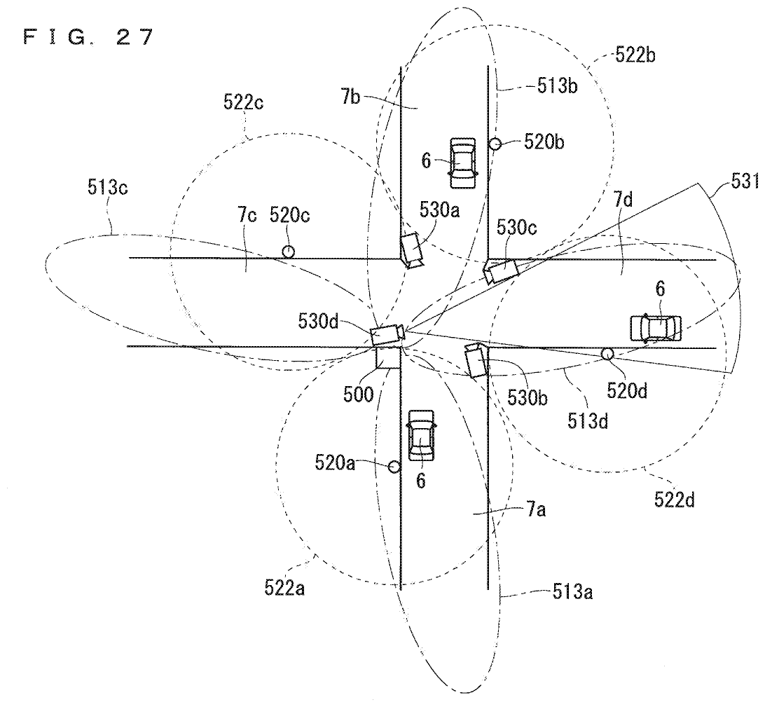

Further, the roadside unit 5 according to one example may comprise a plurality of cameras 530 and the plurality of second communication units 520. FIG. 27 illustrates one example of a state in which the roadside unit 5 according to one example comprises the plurality of cameras 530a to 530d and the plurality of second communication units 520a to 520d.

In one example of FIG. 27, similarly to one example of FIG. 26, concerning each of the plurality of beams 513a to 513d, the first communication unit 510 of the roadside unit 5 transmits, from each corresponding beam, only connection setting information of a second communication unit 520 out of connection setting information of the plurality of second communication units 520a to 520d, for example. The communication area 522 of the second communication unit 520 covers a road along which the corresponding beam extends. Further, in one example of FIG. 27, for example, each of the second communication units 520a to 520d transmits images generated in the plurality of cameras 530a to 530d.

In one example of FIG. 27, similarly to one example of FIG. 26, using 700 MHz band communication, the on-board device 60 of the vehicle 6 on the road 7a receives connection setting information of the second communication unit 520a from the roadside unit 5. With this, using wireless LAN communication, the on-board device 60 of the vehicle 6 on the road 7a can receive and display a plurality of images transmitted from the second communication unit 520a. Similarly, using 700 MHz band communication, the on-board device 60 of the vehicle 6 on the road 7b receives connection setting information of the second communication unit 520b from the roadside unit 5. With this, using wireless LAN communication, the on-board device 60 of the vehicle 6 on the road 7b can receive and display images transmitted from the second communication unit 520b. The same holds true for the on-board device 60 of the vehicle 6 on the roads 7c and 7d.

Note that, in one example of FIG. 27, each second communication unit 520 may transmit, without transmitting an image showing a state of the road 7 covered by its own communication area 522, an image showing a state of another road 7 different from the road 7. For example, the second communication unit 520a may transmit, without transmitting an image showing a state of the road 7a covered by its own communication area 522a (i.e., image generated in the camera 530a), images showing states of the roads 7b to 7d (i.e., images generated in the cameras 530b to 530d). At this time, the second communication unit 520a may not transmit an image showing the road 7 in which no vehicle 6 is present among images showing states of the roads 7b to 7d.

Further, the second communication unit 520b may transmit, without transmitting an image showing a state of the road 7b covered by its own communication area 522b (i.e., image generated in the camera 530b), images showing states of the roads 7a, 7c, and 7d (i.e., images generated in the cameras 530a, 530c, and 530d). At this time, the second communication unit 520b may not transmit an image showing the road 7 in which no vehicle 6 is present among images showing states of the roads 7a, 7c, and 7d. The same holds true for the second communication units 520c and 520d.

Further, in a case where the second communication unit 520a transmits images showing states of the roads 7b to 7d without transmitting an image showing a state of the road 7a, the first communication unit 510 may not transmit connection setting information of the second communication unit 520a from the beam 513a when no vehicle 6 is present on the roads 7b to 7d. Further, in a case where the second communication unit 520b transmits images showing states of the roads 7a, 7c, and 7d without transmitting an image showing a state of the road 7b, the first communication unit 510 may not transmit connection setting information of the second communication unit 520b from the beam 513b when no vehicle 6 is present on the roads 7a, 7c, and 7d. The same holds true for the second communication units 520c and 520d.

Further, the second communication unit 520a may not transmit an image showing a state of the road 7b as well as an image showing a state of the road 7a. In this case, the first communication unit 510 may not transmit connection setting information of the second communication unit 520a from the beam 513a when no vehicle 6 is present on the roads 7c and 7d. Similarly, the second communication unit 520c may not transmit an image showing a state of the road 7d as well as an image showing a state of the road 7c. In this case, the first communication unit 510 may not transmit connection setting information of the second communication unit 520c from the beam 513c when no vehicle 6 is present on the roads 7a and 7b. The same holds true for the second communication units 520b and 520d.

Further, as in the fourth other example, the second communication unit 520 of the roadside unit 5 according to one example may be capable of communication using a plurality of channels, such as the first and second channels. In one example of FIG. 25, in a case where the second communication unit 520 communicates using the first and second channels, for example, the first communication unit 510 transmits the first connection setting information necessary for a connection setting of the first channel from the beams 513a and 513b. With this, the on-board device 60 of the vehicle 6 on the roads 7a and 7b can receive the first connection setting information. Further, for example, the first communication unit 510 transmits the second connection setting information necessary for a connection setting of the second channel from the beams 513c and 513d. With this, the on-board device 60 of the vehicle 6 on the roads 7c and 7d can receive the second connection setting information. Further, for example, the second communication unit 520 transmits, using the first channel, images showing states of the roads 7c and 7d without transmitting images showing states of the roads 7a and 7b. With this, the on-board device 60 of the vehicle 6 on the roads 7a and 7b can receive and display images showing states of the roads 7c and 7d using the first channel. Thus, a driver of the on-board device 60 of the vehicle 6 on the roads 7a and 7b can check states of the roads 7c and 7d that are difficult to be checked with the eye through an image displayed in the on-board device 60. Further, for example, the second communication unit 520 transmits, using the second channel, images showing states of the roads 7a and 7b without transmitting images showing states of the roads 7c and 7d. With this, the on-board device 60 of the vehicle 6 on the roads 7c and 7d can receive and display images showing states of the roads 7a and 7b using the second channel. Thus, a driver of the on-board device 60 of the vehicle 6 on the roads 7c and 7d can check, through an image displayed in the on-board device 60, states of the roads 7a and 7b that are difficult to be checked with the eye.

Note that, in one example of FIG. 25, in a case where second communication unit 520 communicates using the first and second channels, the second communication unit 520 may not transmit an image showing the road 7 in which no vehicle 6 is present among images showing states of the roads 7c and 7d to be transmitted using the first channel, similarly to the fourth other example. Further, the second communication unit 520 may not transmit an image showing the road 7 in which no vehicle 6 is present among images showing states of the roads 7a and 7b to be transmitted using the second channel. Further, the first communication unit 510 may not transmit the first connection setting information of the first channel from the beams 513a and 513b in a case where no vehicle 6 is present on the roads 7c and 7d. In this case, the first communication unit 510 transmits the first connection setting information in a case where the vehicle 6 is present on at least one road of the roads 7c and 7d. Further, the first communication unit 510 may not transmit the second connection setting information of the second channel from the beams 513c and 513d in a case where no vehicle 6 is present on the roads 7a and 7b. In this case, the first communication unit 510 transmits the second connection setting information in a case where the vehicle 6 is present on at least one road of the roads 7a and 7b.

In each example of the above, the first communication unit 510 of the roadside unit 5 and the first communication unit 610 of the on-board device 60 perform the 700 MHz band communication, but may communicate in a wireless communication method other than the 700 MHz band communication.

Further, the second communication unit 520 of the roadside unit 5 and the second communication unit 620 of the on-board device 60 may communicate in a wireless communication method other than a wireless LAN. For example, the second communication unit 520 and the second communication unit 620 may communicate on the basis of Bluetooth, or may communicate on the basis of the device-to-device (D2D) method of Long Term Evolution (LTE). In a case where the second communication unit 520 and the second communication unit 620 communicate on the basis of Bluetooth, the connection setting information contains type information indicating the type of a wireless communication method of a connection partner (information indicating Bluetooth) and a PIN code. In this case, when the connection setting information is to be changed as in the first other example, the PIN code is changed.

Further, the number of the cameras 530 of the roadside unit 5 is not limited to the above example. Further, the number of the second communication units 520 of the roadside unit 5 is not limited to the above example. The number of the cameras 530 of the roadside unit 5 and the number of the second communication units 520 of the roadside unit 5 need not necessarily match.

Further, information transmitted by the first communication unit 510 may be information other than driving safety support information. Further, information transmitted by the second communication unit 520 may be information other than images.

Further, the electronic device 10 owned by the pedestrian 9 may operate similarly to the on-board device 60, and the electronic device 10 present in the vehicle 6 may operate similarly to the on-board device 60.

Further, in the communication system 1, a roadside unit 5 omitting at least one of the first communication unit 510 and the second communication unit 520 may be present. Further, in the communication system 1, an on-board device 60 omitting at least one of the first communication unit 610 and the second communication unit 620 may be present.

As in the above, the communication system 1 has been described in detail, but the above description is in all aspects illustrative, and the present disclosure is not to be limited thereto. Further, various modifications of the above are applicable in combination with one another unless there generates contradiction. Further, it is understood that numerous unillustrated modifications are assumable without departing from the scope of the present disclosure.

1. A roadside unit comprising:
a first communication unit configured to perform communication, based on a first wireless communication method; and
a second communication unit configured to perform communication, based on a second wireless communication method different from the first wireless communication method, wherein
the first communication unit transmits connection setting information necessary for connection setting with the second communication unit.

2. The roadside unit according to claim 1, further comprising
a plurality of second communication units each configured to perform communication, based on the second wireless communication method, wherein
a first communication area of the first communication unit covers an intersection where a plurality of roads are connected, the plurality of roads being covered by respective second communication areas of the plurality of second communication units, and
concerning each of the plurality of second communication units, the first communication unit transmits the connection setting information, and notice information informing that a vehicle, approaching toward a center portion of the intersection from a road covered by one of the respective second communication areas of one of the plurality of second communication units corresponding to the connection setting information, uses the connection setting information.

3. The roadside unit according to claim 1, wherein
a communication area of each of the first communication unit and the second communication unit covers a plurality of roads connected at an intersection,
the second communication unit is capable of communication using a first channel and a second channel,
the first communication unit transmits first connection setting information being the connection setting information of the first channel, and first notice information informing that a vehicle approaching toward a center portion of the intersection from a first road uses the first connection setting information, the first road being comprised in the plurality of roads,
the first communication unit transmits second connection setting information being the connection setting information of the second channel, and second notice information informing that a vehicle approaching toward a center portion of the intersection from a second road uses the second connection setting information, the second road being different from the first road and being comprised in the plurality of roads,
the second communication unit transmits, using the first channel, an image showing a state of a third road without transmitting an image showing a state of the first road the third road being different from the first road in the plurality of roads, and
the second communication unit transmits, using the second channel, an image showing a state of a fourth road without transmitting an image showing a state of the second road, the fourth road being different from the second road in the plurality of roads.

4. The roadside unit according to claim 1, wherein
a first antenna comprised in the first communication unit is an antenna having directivity, and
the first communication unit transmits information from a beam extending along a road in the directivity.

5. The roadside unit according to claim 4, wherein
the first communication unit transmits information from a plurality of beams extending along a respective plurality of roads connected at an intersection, in the directivity.

6. The roadside unit according to claim 5, wherein
the first communication unit generates the plurality of beams by changing directions of the plurality of beams in directivity.

7. The roadside unit according to claim 5, wherein
the first communication unit transmits the connection setting information from a first beam, the first beam being comprised in the plurality of beams, and
the first communication unit does not transmit the connection setting information from a second beam, the second beam being different from the first beam and being comprised in the plurality of beams.

8. The roadside unit according to claim 5, further comprising
a plurality of second communication units each configured to perform communication, based on the second wireless communication method, wherein
second communication areas of the plurality of second communication units cover the respective plurality of roads, and the first communication unit transmits, from one of the plurality of beams, only the connection setting information of one of the plurality of second communication units out of the connection setting information of the plurality of second communication units, the one of the plurality of second communication units comprising one of the second communication areas covering a road along which the one of the plurality of beams extends.

9. The roadside unit according to claim 2, wherein
the plurality of second communication units comprise a third communication unit configured to transmit a plurality of images showing respective states of the plurality of roads.

10. The roadside unit according to claim 8, wherein
the plurality of second communication units comprise a third communication apparatus configured to transmit a plurality of images showing respective states of the plurality of roads.

11. The roadside unit according to claim 2, wherein
the plurality of second communication units comprise a third communication unit, and
the third communication unit transmits an image showing a state of a second road without transmitting an image showing a state of a first road, the first road being covered by one of the second communication areas of the third communication unit and being comprised in the plurality of roads, the second road being different from the first road and being comprised in the plurality of roads.

12. The roadside unit according to claim 8, wherein
the plurality of second communication units comprise a third communication unit, and
the third communication unit transmits an image showing a state of a second road without transmitting an image showing a state of a first road, the first road being covered by one of the second communication areas of the third communication unit and being comprised in the plurality of roads, the second road being different from the first road and being comprised in the plurality of roads.

13. The roadside unit according to claim 11, further comprising
a sensor configured to detect a vehicle on the second road, wherein
the first communication unit transmits the connection setting information of the third communication unit when the sensor detects a vehicle, and
the first communication unit does not transmit the connection setting information of the third communication unit when the sensor does not detect a vehicle.

14. The roadside unit according to claim 12, further comprising
a sensor configured to detect a vehicle on the second road, wherein
the first communication unit transmits the connection setting information of the third communication unit when the sensor detects a vehicle, and
the first communication unit does not transmit the connection setting information of the third communication unit when the sensor does not detect a vehicle.

15. The roadside unit according to claim 5, wherein
a communication area of the second communication unit covers a plurality of roads,
the second communication unit is capable of communication using a first channel and a second channel,
from a first beam, the first communication unit transmits first connection setting information being the connection setting information of the first channel and does not transmit second connection setting information being the connection setting information of the second channel, the first beam extending along a first road and being comprised in the plurality of beams,
from a second beam, the first communication unit transmits the second connection setting information and does not transmit the first connection setting information, the second beam extending along a second road and being comprised in the plurality of beams, the second road being different from the first road,
the second communication unit transmits, using the first channel, an image showing a state of a third road without transmitting an image showing a state of the first road the third road being different from the first road in the plurality of roads, and
the second communication unit transmits, using the second channel, an image showing a state of a fourth road without transmitting an image showing a state of the second road, the fourth road being different from the second road in the plurality of roads.

16. The roadside unit according to claim 3, further comprising
a sensor configured to detect a vehicle on the third road, wherein
the first communication unit transmits the first connection setting information when the sensor detects a vehicle, and
the first communication unit does not transmit the first connection setting information when the sensor does not detect a vehicle.

17. The roadside unit according to claim 15, further comprising
a sensor configured to detect a vehicle on the third road, wherein
the first communication unit transmits the first connection setting information when the sensor detects a vehicle, and
the first communication unit does not transmit the first connection setting information when the sensor does not detect a vehicle.

18. The roadside unit according to claim 16, wherein
using the first channel, the second communication unit transmits a plurality of images showing respective states of a plurality of fifth roads comprising the third road, the plurality of fifth roads being different from the first road in the plurality of roads,
the sensor detects a vehicle on one of the plurality of fifth roads, for each of the plurality of fifth roads,
the first communication unit transmits the first connection setting information when the sensor detects a vehicle on at least one fifth road of the plurality of fifth roads, and
the first communication unit does not transmit the first connection setting information when the sensor does not detect a vehicle on one of the plurality of fifth roads, for each of the plurality of fifth roads.

19. The roadside unit according to claim 17, wherein
using the first channel, the second communication unit transmits a plurality of images showing respective states of a plurality of fifth roads comprising the third road, the plurality of fifth roads being different from the first road in the plurality of roads,
the sensor detects a vehicle on one of the plurality of fifth roads, for each of the plurality of fifth roads,
the first communication unit transmits the first connection setting information when the sensor detects a vehicle on at least one fifth road of the plurality of fifth roads, and
the first communication unit does not transmit the first connection setting information when the sensor does not detect a vehicle on one of the plurality of fifth roads, for each of the plurality of fifth roads.
